(19) United States
(12) Patent Application Publication
(10) Pub. No.: US 2026/0187161 A1
(43) Pub. Date: Jul. 2, 2026

(54) MOBILE APPLICATION AND WEB EXPERIENCE FOR DATA COLLECTION AND LOGBOOK CREATION

(71) Applicant: Jeff Blood Fly Fishing LLC, Cranberry Township, PA (US)

(72) Inventor: Jeffrey L. Blood, Cranberry Township, PA (US)

(21) Appl. No.: 19/297,758

(22) Filed: Aug. 12, 2025

Related U.S. Application Data
(60) Provisional application No. 63/683,413, filed on Aug. 15, 2024.

(51) Int. Cl. G06F 16/951; G06F 16/9537; G06F 40/279; G06Q 50/02

(52) U.S. Cl. CPC G06F 16/951; G06F 16/9537; G06F 40/279; G06Q 50/02

(57) ABSTRACT

A mobile device receives voice input from a user during a fishing event. The mobile device processes the voice input using natural language processing and natural language understanding to identify trigger words. The mobile device performs actions based on the trigger words. The mobile device may drop a virtual pin on a map to mark a location. The mobile device retrieves data from the internet related to the fishing event. The mobile device may log data points, including GPS coordinates, species, size, fishing method, tackle used, weather conditions, water conditions, timestamps, etc. The mobile device may communicate with external data collection devices using wireless communication to supplement the data. The mobile device may compile logged data into an electronic logbook. The electronic logbook may comprise a timeline and summary statistics for the fishing event. A cloud storage system may store the compiled data for later access and management.

### RELATED APPLICATION

Under provisions of 35 U.S.C. § 119(e), the Applicant claims benefit of U.S. Provisional Application No. 63/683,413 filed on Aug. 15, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present relates to mobile applications and web-based systems for data collection and logbook creation, specifically targeting the sport fishing industry.

### BACKGROUND

Conventional sport fishing data collection systems typically rely on manual input mechanisms that require direct user interaction with electronic devices. Most existing systems utilize touch-based interfaces where users must tap buttons, select options from dropdown menus, or type information using on-screen keyboards. These systems often require users to navigate through multiple screens to input basic fishing data such as species identification, catch measurements, and location information.

Many current fishing applications focus primarily on social media functionality rather than comprehensive data logging. Users must manually photograph their catches, manually enter catch details, and manually share information across social platforms. The data entry process typically occurs after the fishing event has concluded, relying on user memory to accurately recall specific details about timing, location, and environmental conditions.

Some existing systems attempt to automate data collection through accelerometer-based detection methods. These systems monitor device movement patterns to identify potential fishing activities such as casting or fish strikes. However, accelerometer-based approaches have proven unreliable in distinguishing between actual fishing events and other routine movements during fishing trips.

Traditional paper-based logbooks remain common among serious anglers who manually record fishing data using pen and paper. These physical logbooks require users to write detailed entries by hand, often in challenging outdoor conditions with wet hands or poor lighting. The manual transcription process is time-consuming and prone to errors or omissions.

Current digital fishing applications typically operate in isolation without integration capabilities for external environmental monitoring devices. Users must separately record data from fish finders, water temperature gauges, or weather monitoring equipment. This fragmented approach results in incomplete data sets that fail to capture the full environmental context of fishing events.

Existing cloud-based fishing platforms generally require users to manually upload and organize their fishing data after each trip. The synchronization process involves multiple manual steps including photo uploads, data entry verification, and manual categorization of fishing events. These systems lack real-time data compilation capabilities during active fishing periods.

Current GPS-enabled fishing applications typically require users to manually activate location marking functions through touch-based interfaces. Users must physically interact with their mobile devices to record waypoints, often while simultaneously managing fishing equipment. This manual activation process frequently results in missed location data when users are occupied with active fishing situations.

Weather integration in existing fishing platforms generally operates through separate applications or requires manual data retrieval. Users must exit their primary fishing application to check weather conditions or manually input environmental data. The disconnected nature of these systems prevents real-time correlation between environmental conditions and fishing events.

Photo documentation in traditional fishing applications requires multiple manual steps including camera activation, image capture, and subsequent tagging or categorization. Users must manually associate photographs with specific fishing events through time-consuming post-processing workflows. The manual photo organization process often results in incomplete documentation or misassigned image metadata.

Professional fishing guide applications typically lack functionality to distinguish between personal fishing activities and client-related services. Guides must manually separate their own fishing data from client trip information through cumbersome categorization processes. The absence of automated client-guide data separation creates administrative burdens and potential data privacy complications.

Battery management presents ongoing challenges for mobile fishing applications that require continuous GPS tracking and data collection. Extended fishing trips often exceed typical smartphone battery life, forcing users to choose between device functionality and comprehensive data logging. Power consumption optimization remains problematic for applications requiring simultaneous voice processing, GPS monitoring, and wireless connectivity.

Data synchronization across multiple devices creates compatibility issues for fishing enthusiasts who utilize tablets, smartphones, and other mobile platforms. Users must manually transfer fishing data between devices or maintain separate logbooks on each platform. The lack of seamless cross-device synchronization results in fragmented fishing records and data inconsistency.

Internet connectivity limitations in remote fishing locations prevent real-time environmental data retrieval and cloud storage synchronization. Users often fish in areas with limited cellular coverage, rendering internet-dependent features inoperable. The dependency on continuous internet connectivity restricts application functionality during offline fishing scenarios.

Voice recognition accuracy degrades significantly in outdoor fishing environments due to ambient noise from water movement, wind, and equipment operation. Existing voice processing systems struggle to distinguish between intentional commands and background conversations or environmental sounds. The reduced recognition reliability in outdoor conditions limits practical voice-based interaction capabilities.

External sensor integration typically requires complex manual pairing procedures and device-specific configuration protocols. Users must individually connect and configure each external monitoring device through separate setup processes. The complexity of multi-device integration often prevents users from utilizing comprehensive environmental monitoring capabilities.

Data export functionality in current fishing applications generally provides limited format options and requires manual file management. Users must navigate through multiple export procedures to transfer fishing data to external analysis platforms. The restricted export capabilities prevent integration with professional fishing analysis software or research databases.

Several commercial fishing applications attempt to address sport fishing data collection through various approaches. FishBrain provides a social fishing platform where users manually enter catch information through touch-based interfaces and share photographs with the community. The application requires users to tap through multiple screens to input species, location, and catch details after completing their fishing activities.

AnglerLogs offers digital logbook functionality that relies entirely on manual data entry through dropdown menus and text input fields. Users must navigate complex interface hierarchies to record basic fishing information such as bait selection, weather conditions, and catch measurements. The system requires users to remember and manually input all relevant data points after returning from fishing trips.

Fishidy provides GPS-enabled fishing spot mapping with manual waypoint creation through touch-based controls. Users must physically interact with their mobile devices to mark locations while simultaneously managing fishing equipment. The application lacks integration with external environmental monitoring devices and requires separate manual entry for weather and water condition data.

Pro Angler utilizes accelerometer-based detection methods to identify potential fishing activities through device movement patterns. The system monitors casting motions and sudden jerking movements to trigger automatic data collection events. However, the accelerometer approach frequently generates false positives from routine boat movements, walking, or equipment handling activities.

Catch and Release employs manual photograph documentation workflows where users must activate camera functions, capture images, and subsequently tag photographs to specific fishing events through time-consuming post-processing procedures. The application requires users to manually associate each photograph with catch details through separate data entry screens.

These existing solutions prove inadequate for practical sport fishing data collection due to their reliance on manual input mechanisms during active fishing periods. Touch-based interfaces become impractical when users have wet hands or are occupied with fighting fish. Manual data entry workflows interrupt the fishing experience and frequently result in incomplete or inaccurate records due to delayed input timing.

Accelerometer-based detection systems demonstrate unreliable performance in distinguishing between actual fishing events and routine movements during fishing activities. The high false positive rates render these systems impractical for accurate event logging. Environmental noise and equipment vibrations further degrade accelerometer detection accuracy.

Current applications lack seamless integration capabilities with external environmental monitoring equipment. Users must maintain separate devices and manually correlate data from fish finders, water temperature sensors, and weather monitoring instruments. The fragmented data collection approach prevents comprehensive environmental context recording.

Battery consumption optimization remains problematic for applications requiring continuous GPS tracking and data monitoring throughout extended fishing trips. Most existing systems drain mobile device batteries rapidly, forcing users to choose between device functionality and comprehensive data logging capabilities.

Internet connectivity dependencies limit functionality in remote fishing locations where cellular coverage is unreliable or unavailable. Many current applications require continuous internet access for core features, rendering them inoperable during offline fishing scenarios where comprehensive data collection is most valuable.

Therefore, there exists a substantial need for a comprehensive sport fishing data collection system that operates seamlessly during active fishing periods without requiring manual device interaction or disrupting the fishing experience. Such a system would eliminate the practical barriers that prevent consistent data logging while providing accurate, comprehensive documentation of fishing activities and environmental conditions in real-time.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The mobile device may receive voice input from a user during a fishing event. The mobile device may process the voice input using natural language processing (NLP) and natural language understanding (NLU) to identify key trigger words. The mobile device may perform actions based on the identified key trigger words, wherein the actions may comprise dropping pins on a map to mark locations. The actions may comprise retrieving data from the internet related to the fishing event. The actions may comprise logging data points comprising GPS coordinates, species, size, fishing method, tackle used, weather conditions, water conditions, and timestamps. The mobile device may integrate data from external data collection devices (DCDs) via wireless communication to enhance the data set. The mobile device may compile the logged data into an electronic logbook, wherein the logbook may comprise a timeline and summary statistics of the fishing event. A cloud storage system may store the compiled data for subsequent access and management. The mobile device may allow the user to set up profiles and preferences. The mobile device may provide options for professional guides to track personal versus client fishing activities. Privacy may be ensured by allowing users to keep specific fishing spots private while providing aggregated data for broader analysis.

A system for collecting and logging sport fishing data may comprise a mobile device comprising a processor, memory, microphone, GPS module, and wireless communication interface. The system may comprise a voice interaction module configured to receive voice input from a user during a fishing event. The system may comprise a natural language processing module configured to process the voice input to identify key trigger words. The system may comprise an event logging module configured to perform actions based on the identified key trigger words, wherein the actions may comprise dropping pins on a map, retrieving environmental data, and logging data points comprising GPS coordinates, species information, and timestamps. The system may comprise an integration module configured to receive data from external data collection devices via the wireless communication interface. The system may comprise a data compilation module configured to compile the logged data into an electronic logbook comprising a timeline and summary statistics. The system may comprise a cloud storage system configured to store the compiled data. The system may comprise a display module configured to present the electronic logbook to the user.

The mobile device may monitor ambient audio continuously during a fishing trip. The mobile device may detect fishing-related audio signatures comprising sounds of fish strikes, reel drag, and line tension. The mobile device may automatically trigger data collection upon detection of the audio signatures without requiring voice commands. The mobile device may capture environmental sensor data comprising water temperature, barometric pressure, and wind conditions at the moment of detection. The mobile device may correlate the detected audio signatures with GPS coordinates and timestamps to create event markers. The mobile device may generate predictive catch probability scores based on accumulated environmental data patterns and historical fishing success rates.

The key trigger words may comprise phrases such as “fish on,” “take a note,” “fish landed,” and “fish lost.” To acknowledge the event trigger, the system may notify the user of detected events through haptic feedback or audio alerts. The voice input may be filtered to remove background noise and improve accuracy of the natural language processing.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a screenshot of a first interface for displaying an electronic logbook;

FIG. 3 is a screenshot of a second interface for displaying an electronic logbook;

FIG. 4 is a flow chart of a method for providing a data collection and logbook creation platform;

FIGS. 5A-5C show a workflow diagram showing a specific workflow for a sportfishing data collection and logbook creation platform;

FIG. 6 is a flow chart of a method for collecting and logging sport fishing data; and

FIG. 7 is a block diagram of a system including a computing device for performing the method of FIG. 4 and/or FIGS. 5A-5C.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The technical problem being solved by the present disclosure relates to the fundamental challenges associated with documenting fishing activities during active fishing events. Traditional methods of data collection may present significant obstacles for anglers who attempt to maintain comprehensive records of their fishing experiences. Manual documentation techniques may require physical interaction with writing instruments or electronic devices during moments when an angler's attention and hands may be occupied with managing fishing equipment, handling caught fish, or responding to changing fishing conditions.

The primary use case addresses the scenario where an angler may be engaged in active sport fishing activities and encounters a fish strike or hookup event. During such moments, the angler may experience heightened physical and emotional intensity while managing fishing equipment, fighting the fish, and attempting to successfully land the catch. Traditional documentation methods may require the angler to divert attention from these activities to manually record information about the event, location, environmental conditions, and catch details. This interruption may potentially compromise the angler's ability to effectively manage the fishing situation and may result in incomplete or inaccurate data collection.

The technical challenges may extend beyond the immediate moment of fish interaction. Environmental conditions common to fishing activities may create additional barriers to effective data collection. Wet conditions may make handling of electronic devices or writing materials impractical or potentially damaging to equipment. Cold weather conditions may reduce manual dexterity and make precise input operations difficult to perform. Wind, rain, or other weather factors may interfere with the ability to maintain stable control of documentation tools while simultaneously managing fishing activities.

Professional fishing guides may encounter compounded documentation challenges when managing multiple clients during guided fishing excursions. The guide may need to simultaneously monitor multiple fishing lines, assist clients with equipment management, provide instruction and guidance, and attempt to document fishing events for multiple participants. Traditional manual documentation methods may prove inadequate for capturing comprehensive data across multiple simultaneous fishing activities while maintaining the quality of client service expected in professional guide operations.

The technical problem may also encompass the integration of diverse data sources that may contribute to comprehensive fishing documentation. Environmental factors such as water temperature, air temperature, barometric pressure, wind conditions, and lunar phase may significantly influence fishing success and may provide valuable context for analyzing fishing patterns over time. Traditional documentation methods may require anglers to consult multiple separate instruments or data sources and manually correlate this information with fishing event data, creating opportunities for errors and omissions in the documentation process.

Location documentation may present additional technical challenges in traditional systems. Accurate geographic positioning may be essential for identifying productive fishing locations and enabling future return visits to successful areas. Manual methods of location marking may rely on visual landmarks or approximate descriptions that may prove insufficient for precise location identification. GPS technology may provide accurate positioning data, but integrating this information with other fishing event data through traditional methods may require additional manual steps that may be impractical during active fishing moments.

Data organization and long-term storage may create further technical obstacles with conventional documentation approaches. Paper-based logbooks may be susceptible to damage from water exposure, may be difficult to search or analyze for patterns, and may not provide mechanisms for backup or sharing of information. Digital documentation systems that require manual data entry may be time-consuming to maintain and may discourage consistent use due to the effort required for comprehensive data input.

Privacy considerations may present additional challenges in fishing documentation systems. Anglers may desire to maintain detailed records of successful fishing locations while simultaneously protecting sensitive location information from disclosure to other anglers who might exploit productive fishing areas. Traditional systems may not provide mechanisms for selective data sharing that allow anglers to contribute to broader fishing data analysis while maintaining control over location-specific information.

The technical problem may also encompass the need for real-time data correlation during fishing events. Successful fishing documentation may benefit from capturing precise temporal relationships between environmental conditions, angler actions, and fish behavior. Traditional methods may not provide mechanisms for accurately timestamping events or correlating multiple data streams in real-time, potentially resulting in loss of valuable contextual information that could inform future fishing strategies.

The disclosed platform provides a comprehensive solution for hands-free data collection during sport fishing and/or other activities through voice-activated technology and automated data integration. The system addresses the fundamental challenges of traditional manual documentation methods by enabling anglers to focus on their fishing activities while comprehensive data logging occurs seamlessly in the background.

The mobile application platform may receive voice input from users during fishing events and may process this input using advanced natural language processing and natural language understanding algorithms. The system may identify specific trigger words and phrases that correspond to various fishing activities and events. Upon detecting these predetermined keywords, the platform may automatically initiate data collection sequences without requiring manual intervention from the user.

Voice interaction systems may continuously monitor ambient audio for fishing-related terminology and commands. When trigger words such as “fish on” or “take a note” are detected, the system may immediately begin capturing relevant data points associated with the event. Natural language processing may filter background noise and environmental sounds to improve accuracy of voice recognition in outdoor fishing environments.

The event logging may automatically record precise GPS coordinates and timestamps for each triggered event. The system may drop pins on digital maps to mark specific locations where fishing activities occur. Environmental data retrieval may occur simultaneously through internet services, which may gather real-time weather conditions, barometric pressure readings, moon phase information, and water conditions from external databases and meteorological services.

External data collection devices may enhance the comprehensive nature of the logged information. The system may communicate with stream thermometers, water depth gauges, and other specialized fishing equipment through wireless protocols such as Bluetooth. These connected devices may provide additional environmental parameters that may influence fishing success and may contribute valuable context to each recorded event.

The system may compile data, aggregating information from multiple sources and may structure the collected data into organized electronic logbook entries. Each entry may include GPS coordinates, species information, fish size measurements, tackle specifications, environmental conditions, and temporal data. The system may generate summary statistics and may calculate hourly catch rates and success metrics for each fishing session.

Professional fishing guides may benefit from specialized functionality that allows separation of personal and client fishing activities. The user profile and preferences may provide toggle capabilities between business and personal modes. Guide users may track individual client experiences and may generate trip reports and documentation for professional services while maintaining separate records for their own fishing activities.

Privacy management features may allow users to control the visibility of sensitive location information. Anglers may keep specific fishing spots private while contributing to aggregated data analysis that benefits the broader fishing community. The system may provide selective data sharing capabilities that enable participation in fisheries research and management while protecting individual fishing location preferences.

Photo integration may automatically associate captured images and videos with specific fishing events based on temporal proximity and geolocation data. Photos taken during fishing trips may be tagged to corresponding logbook entries, creating comprehensive visual documentation of fishing experiences. The system may organize media files within the electronic logbook and may provide gallery functionality for reviewing and managing fishing-related photography.

Cloud storage systems may provide secure data management and may enable access to fishing records across multiple devices. The cloud storage may implement encryption protocols and may maintain backup systems to protect user data. Synchronization capabilities may ensure that logbook information remains current and accessible from smartphones, tablets, and web-based interfaces.

Fishing data may be displayed or presented through various interface formats including timeline views, map displays, and statistical summaries. Users may navigate through their fishing history and may analyze patterns and trends across multiple fishing sessions. Interactive features may allow filtering of data based on species, location, date ranges, and other criteria. The interface may adapt to different screen sizes and may provide optimized viewing experiences for mobile devices and desktop computers.

Advanced audio signature detection capabilities may enhance the automated nature of the system. The platform may monitor for fishing-related sounds such as fish strikes, reel drag activation, and line tension events. Machine learning algorithms may distinguish between different audio patterns and may trigger data collection without requiring voice commands. This passive monitoring approach may capture fishing events that occur without verbal indication from the angler.

Environmental sensor integration may extend beyond basic temperature and pressure measurements. The system may interface with sonar devices for water depth information and may correlate catch data with underwater topography and structure information. Water quality sensors may provide dissolved oxygen levels, pH measurements, and turbidity data that may influence fish behavior and feeding patterns.

Predictive analytics functionality may emerge from accumulated data patterns. The system may analyze historical fishing success rates in relation to environmental conditions and may generate probability scores for future fishing success. These predictive models may consider seasonal variations, weather patterns, and historical catch data to provide anglers with data-driven insights for planning fishing excursions.

The platform may support multiple fishing disciplines including freshwater angling, saltwater fishing, fly fishing, and ice fishing applications. Different fishing methods may require specialized data fields and may benefit from customized trigger word vocabularies. The system may adapt to various fishing environments and may provide relevant data collection capabilities for diverse angling scenarios.

Integration with fisheries management databases may provide regulatory compliance features. The system may monitor catch limits and may alert users when approaching harvest restrictions for specific species or fishing areas. This functionality may help anglers maintain compliance with local fishing regulations and may contribute to sustainable fishing practices.

Real-time data sharing capabilities may enable collaborative fishing experiences. Multiple anglers fishing together may contribute to shared logbooks and may coordinate their data collection efforts. Professional guides may manage data for multiple clients simultaneously and may provide comprehensive trip documentation for guided fishing services.

The system may incorporate weather forecasting integration that extends beyond current conditions. Future weather predictions may be correlated with historical fishing success data to provide recommendations for optimal fishing timing. Barometric pressure trends and weather pattern analysis may inform fishing strategy decisions based on accumulated data insights.

The present disclosure includes many aspects and features. Moreover, while many aspects and features relate to, and are described in, the context of sport fishing data collection and logbook creation, embodiments of the present disclosure are not limited to use only in this context. For example, those of skill in the art will recognize that the platform may have applications in hunting, hiking, or other outdoor sports and recreation activities. Accordingly, while the specification describes uses for sport fishing, those of skill in the art will recognize that uses for other outdoor sport and recreation activities are also within the scope of this invention.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Sport fishing enthusiasts often seek to document their fishing experiences, including details such as the number of fish caught, species, size, and environmental conditions. Traditionally, this documentation process involves manual methods, such as writing in a logbook or using systems that require manual input through tapping, clicking, or typing. These methods can be cumbersome and impractical, especially during the high-intensity moments of hooking, fighting, and landing a fish.

Manual data collection and data input is the historical method to build a fishing logbook by simply writing the information down. Some applications have attempted a logbook and data gathering by tapping, clicking, or typing to log data. These methods are cumbersome and require the user to manually interact with the application for data entry during the elevated emotional state of hooking, fighting, and landing a fish. This is an obstacle to practical use and why they are not embraced. Currently, no applications address the need at a level making sense and most fishing applications are actually more targeted to social media than data collection. Some applications use manual tapping or clicking of the smartphone or smartwatch for data input but have severe limitations in data differentiation and these methods interfere with the act of fishing. Accelerometers built into specialized devices placed on fishing rods have been used by some applications to attempt to detect strikes and or actual hookups to fish but have failed. Theoretically a good idea but not practical.

The present disclosure relates to a mobile application and web experience targeted to the sport fishing industry that collects data about the experience by listening for words said by the fisherman. The voice interaction is collected by a smartphone and/or other electronic devices and occurs in the background without requiring any manual input from the user. Rather, the device begins operation upon turning the device on and setting the initial settings. The data from the initial settings and the voice interactions is used to build an electronic logbook of each fishing event. The fisherman simply says the words that come to mind as fish are hooked, fought, lost, or landed. Words trigger actions such as dropping pins on a map, grabbing data from the internet, and tabulating statistical data about each fishing event using a smartphone. The application uses state-of-the-art natural language processing and natural language understanding. The application also interacts with other devices, data collection devices such as stream or water thermometers to further enhance the data set. Listening is accomplished by the smartphone or other devices such as microphones, pendants, or watches.

The platform of the present disclosure allows for hands-free data collection during fishing events by utilizing voice input, which is processed using natural language processing (NLP) and natural language understanding (NLU) to identify key trigger words. This eliminates the need for manual data entry, making the process more convenient and less intrusive for the user, especially during high-intensity moments such as hooking, fighting, and landing a fish.

By dropping pins on a map to mark locations and retrieving data from the internet related to the fishing event, the platform provides a comprehensive and automated way to log important details such as GPS coordinates, species, size, fishing method, tackle used, weather conditions, water conditions, and timestamps. This integration of various data points into an electronic logbook enhances the accuracy and richness of the recorded information.

The ability of the platform to integrate data from external data collection devices (DCDs) via Bluetooth further enhances the data set by including additional environmental parameters such as water temperature and depth. This results in a more detailed and informative logbook, which can be valuable for analyzing fishing patterns and making data-driven decisions for future fishing trips.

Storing the compiled data in a cloud storage system ensures that the information is securely saved and easily accessible for subsequent access and management. This cloud-based storage solution provides users with the flexibility to retrieve and manage their fishing data from any location, enhancing the overall user experience.

The platform also includes features for setting up user profiles and preferences, including options for professional guides to track personal versus client fishing activities. This customization capability allows for a tailored user experience, catering to the specific needs of different types of users, whether they are individual anglers or professional fishing guides.

Ensuring privacy by allowing users to keep specific fishing spots private while providing aggregated data for broader analysis addresses privacy concerns and encourages user adoption. This feature balances the need for personal data security with the benefits of contributing to broader fishing data analysis, which can be useful for fisheries management and other purposes.

The disclosed platform comprises a mobile application and web-based platform designed for the sport fishing industry to facilitate the collection and logging of fishing data. The platform operates by receiving voice input from users during fishing events, which is processed using natural language processing (NLP) and natural language understanding (NLU) to identify trigger words. Upon recognizing these trigger words, the platform performs specific actions such as dropping pins on a map to mark locations, retrieving relevant data from the internet, and logging various data points including GPS coordinates, species, size, fishing method, tackle used, weather conditions, water conditions, and timestamps. This voice interaction occurs in the background, requiring minimal manual input from the user beyond the initial setup and activation of the application.

The platform integrates data from external data collection devices (DCDs) via Bluetooth or other connection means, enhancing the dataset with additional environmental parameters such as water temperature and depth. The collected data is compiled into an electronic logbook, which includes a timeline and summary statistics of the fishing event. This logbook is stored in a cloud storage system, ensuring secure and accessible data management. Users can set up profiles and preferences, with options for professional guides to track personal versus client fishing activities. The platform also addresses privacy concerns by allowing users to keep specific fishing spots private while providing aggregated data for broader analysis.

Embodiments of the present disclosure may comprise methods, systems, and a computer readable medium comprising, but not limited to, at least one of the following:
A. A Voice Interaction Module;
B. A Natural Language Processing Module;
C. An Event Logging Module;
D. An Integration Module;
E. A Data Compilation Module;
F. A User Profile and Preferences Module;
G. A Photo Integration Module;
H. A Cloud Storage System;
I. An Internet Service Module;
J. A Display Module; and

### K. Alternative Embodiments.

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components as found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, via a mobile application on a smartphone or other electronic device, voice

input from a user during a fishing event;
processing the voice input using natural language processing (NLP) and natural

language understanding (NLU) to identify key trigger words;
performing actions based on the identified key trigger words, wherein the actions

include:
dropping pins on a map to mark locations;
retrieving data from the internet related to the fishing event;
logging data points including GPS coordinates, species, size, fishing method, tackle used,

weather conditions, water conditions, and timestamps;
integrating data from external data collection devices (DCDs) via Bluetooth to enhance

the data set;
compiling the logged data into an electronic logbook, wherein the logbook includes a timeline and summary statistics of the fishing event;
storing the compiled data in a cloud storage system for subsequent access and management;

Although the aforementioned method has been described to be performed by the sport fishing data collection and logbook platform 100, it should be understood that computing device 700 may be used to perform the various stages of the method. Furthermore, in some embodiments, different operations may be performed by different networked elements in operative communication with computing device 700. For example, a plurality of computing devices may be employed in the performance of some or all of the stages in the aforementioned method. Moreover, a plurality of computing devices may be configured much like a single computing device 700. Similarly, an apparatus may be employed in the performance of some or all stages in the method. The apparatus may also be configured much like computing device 700.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

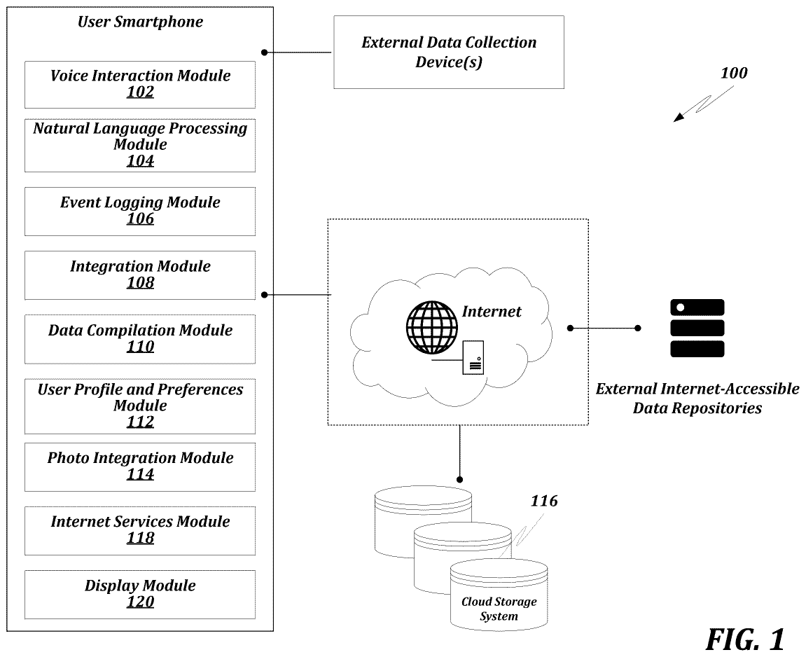

FIG. 1 illustrates one possible operating environment through which a platform consistent with embodiments of the present disclosure may be provided. By way of non-limiting example, a sport fishing data collection and logbook platform 100 may be hosted on, for example, a cloud computing service. In some embodiments, the platform 100 may be hosted on a computing device 700. A user may access platform 100 through a software application and/or hardware device. The software application may be embodied as, for example, but not be limited to, a website, a web application, a desktop application, and a mobile application compatible with the computing device 700.

The platform may support automated fishing event detection through advanced audio signature recognition capabilities. The voice interaction module 102 may monitor ambient audio continuously during fishing activities to identify specific sound patterns associated with fishing events. Machine learning algorithms may be trained to recognize distinctive audio signatures such as fish strikes against lures, reel drag activation sounds, and line tension vibrations. These audio patterns may be processed in real-time to trigger data collection sequences without requiring verbal commands from the user.

Audio signature detection may employ frequency analysis techniques to distinguish between different types of fishing-related sounds. The system may analyze audio input across multiple frequency ranges to identify characteristic patterns associated with various fishing events. Low-frequency sounds may indicate large fish strikes, while higher-frequency patterns may correspond to smaller fish interactions or equipment-related events. The natural language processing module 104 may incorporate spectral analysis capabilities to differentiate between environmental noise and fishing-specific audio signatures.

The integration module 108 may interface with specialized acoustic sensors designed for underwater sound detection. Hydrophone devices may be connected via wireless communication protocols to capture underwater audio signatures that may not be audible through standard microphone systems. These underwater acoustic sensors may detect fish movement patterns, feeding behaviors, and strike events that occur below the water surface. The integration module 108 may correlate underwater audio data with surface-level events to provide comprehensive fishing event documentation.

Environmental monitoring may extend beyond fish-related sounds to include factors such as weather pattern recognition, thermoclines and/or water chemistry. The system may identify changing weather conditions such as wind intensity variations, precipitation patterns, and water movement characteristics. As examples, these changes in weather may be identified based at least in part on audio signatures associated with the changes, position-based weather determination, and/or one or more external data collection devices (DCDs) detecting and collecting weather information (e.g., precipitation, wind speed, barometric pressure, etc.). These environmental cues may be integrated with meteorological data retrieved through the internet service module 118 to provide enhanced environmental context for fishing events.

Additionally or alternatively, DCDs may be used to collect information related to thermoclines and/or water chemistry. The depth of a lake's thermocline, the layer of rapid temperature change, may vary from lake to lake, and is influenced by factors including lake size (e.g., volume, depth), water clarity, and weather. In deeper lakes, the thermocline can be found around 20-30 feet, while in shallower lakes, the thermocline may be as shallow as 6-12 feet. The thermocline acts as a boundary between warmer surface water and colder deep water, effectively separating the water column into distinct layers, with each layer having different species living therein. Water chemistry may also influence species distribution within the water. Water chemistry may include factors such as water pH, oxygen levels in the water, salinity levels in the water, and/or the like. Different species of fish often prefer specific water chemistries, and knowing these chemistries may be useful in predicting where fish of a particular species may be located.

The event logging module 106 may automatically initiate data collection upon detection of predefined audio signatures without requiring voice activation. Strike detection algorithms may analyze audio input for sudden amplitude changes and frequency patterns characteristic of fish strikes on fishing lures or bait. The system may distinguish between false positives caused by environmental factors and actual fishing events through pattern recognition techniques trained on extensive audio datasets.

Real-time audio processing may occur locally on the mobile device to minimize latency in event detection and data logging. The voice interaction module 102 may employ edge computing techniques to perform initial audio analysis without requiring cloud-based processing. This approach may ensure that fishing events are captured immediately upon occurrence, even in areas with limited internet connectivity. Local processing capabilities may include noise filtering, frequency analysis, and pattern matching algorithms optimized for mobile device hardware.

The data compilation module 110 may incorporate audio event metadata into electronic logbook entries to provide additional context for fishing experiences. Audio signature characteristics such as strike intensity, duration, and frequency patterns may be recorded alongside traditional fishing data points. This audio metadata may enable users to analyze correlations between specific sound patterns and fishing success rates across multiple fishing sessions.

Machine learning models may continuously improve audio signature recognition accuracy through user feedback and validation. The system may present detected audio events to users for confirmation, allowing the machine learning algorithms to refine their recognition capabilities based on validated fishing event data. Over time, the audio detection system may become increasingly accurate at distinguishing between different types of fishing events and environmental noise patterns.

The photo integration module 114 may automatically associate captured images with audio-detected fishing events based on temporal correlation. When an audio signature triggers an event logging sequence, the system may monitor for photographs taken within a specified time window following the detected event. This automated photo tagging capability may reduce the manual effort required to associate visual documentation with specific fishing events while maintaining accurate chronological records.

Privacy considerations may be addressed through local audio processing and selective data transmission. The voice interaction module 102 may process audio signatures locally without transmitting raw audio data to cloud storage systems. Only processed event metadata and confirmed fishing event data may be transmitted to the cloud storage system 116, ensuring that private conversations and environmental sounds are not stored or transmitted beyond the user's device.

The display module 120 may present audio event analysis through visual representations of detected sound patterns. Spectrogram displays may show frequency content of detected audio signatures, allowing users to visually analyze the characteristics of different fishing events. These visual representations may help users understand the relationship between audio patterns and fishing success, potentially improving their ability to recognize productive fishing conditions.

Calibration procedures may allow users to customize audio signature detection sensitivity based on their specific fishing environments and equipment. The system may provide adjustment controls for different types of fishing scenarios, such as freshwater versus saltwater environments, different rod and reel configurations, and varying background noise conditions. These calibration settings may be stored in user profiles managed by the user profile and preferences module 112.

Integration with wearable devices may expand audio signature detection capabilities through multiple sensor inputs. Smartwatches or fitness trackers may provide additional accelerometer and gyroscope data that complements audio signature detection. The integration module 108 may correlate motion sensor data from wearable devices with audio signatures to improve event detection accuracy and reduce false positive detections.

The system may support collaborative audio signature database development through anonymized data sharing. Users may contribute validated audio signature patterns to a shared database that improves detection accuracy for all platform users. This collaborative approach may accelerate machine learning model training while maintaining individual user privacy through data anonymization techniques.

Advanced signal processing techniques may enable the system to detect subtle audio signatures in challenging acoustic environments. Adaptive filtering algorithms may adjust to varying background noise conditions, allowing the system to maintain detection sensitivity in windy conditions, near flowing water, or in the presence of other environmental sounds. These adaptive capabilities may ensure consistent performance across diverse fishing environments and conditions.

Accordingly, embodiments of the present disclosure provide a software and hardware platform comprised of a distributed set of computing elements, including, but not limited to:

### A. a Voice Interaction Module

In embodiments, the platform 100 may include a voice interaction module 102. The voice interaction module may include hardware and/or software configured to collect data about an event by listening for key words spoken by a user. In embodiments, the voice interaction module 102 may operate in the background without requiring manual input other than turning on the application and setting initial settings.

The voice interaction module 102 may operate as a component of a mobile application, designed to facilitate hands-free data collection during fishing events. The voice interaction module 102 may receive, as input, data from one or more microphones. For example, the microphone may be incorporated into a mobile device running the mobile application portion of the platform 102, and/or an external microphone connected to the mobile device. In embodiments, the voice interaction module may continuously “listen” or monitor the received input for specific keywords spoken by the user. The keywords may be predefined words or phrases that cause the platform to take an action. The keywords may include, as non-limiting examples, “fish on,” “take a note,” “fish landed,” “fish lost.” Responsive to detecting one of the predefined keywords, the voice interaction module 102 may cause the platform 100 to initiate one or more predefined actions, without requiring any manual input from the user. This functionality allows the user to focus on fishing activities while the platform autonomously logs relevant data.

To achieve accurate voice recognition, the voice interaction module 102 may employ advanced natural language processing (NLP) and/or natural language understanding (NLU) techniques (e.g., via the natural language processing module 104). These techniques enable the platform 100 to interpret the spoken words of the user, even in environments with background noise typical of outdoor settings.

Responsive to the voice interaction module 102 identifying a keyword, the voice interaction module may trigger one or more specific actions based on the identified keyword. As non-limiting examples, the voice interaction module 102 may cause the platform 100 to drop a pin on a map to mark the location of the event, retrieve data from the internet, and/or log various data points including (but not limited to) one or more of GPS coordinates, species, size, fishing method, tackle used, weather conditions, water conditions, and timestamp. In some embodiments, the voice interaction module 102 may cause the platform 100 to gather data points using one or more other platform modules (e.g., event logging module 106, the integration module 108, the internet service module 118, etc.). Additionally or alternatively, the voice interaction module may receive one or more of the data points via voice input from the user (e.g., via the natural language processing module 104).

The voice interaction module 102 operates in the background, allowing the user to interact with the platform 100 seamlessly and without interruption. This hands-free approach enhances the user experience by minimizing the need for manual data entry, thereby making the process more efficient and less intrusive.

The noise filtering implementation for voice input processing may employ multiple complementary techniques to ensure accurate voice recognition in challenging outdoor fishing environments. The voice interaction module 102 may incorporate adaptive filtering algorithms that may dynamically adjust to varying acoustic conditions encountered during fishing activities. These adaptive filters may continuously monitor the ambient noise characteristics and may modify their response parameters in real-time to optimize voice signal extraction.

Wiener filtering may be employed as an additional noise reduction technique that may minimize the mean square error between the desired clean speech signal and the filtered output. The Wiener filter may be implemented using frequency domain processing where the voice input may be transformed using Fast Fourier Transform algorithms. The filter coefficients may be calculated based on the power spectral densities of the speech signal and the noise components, allowing for optimal noise suppression while preserving speech intelligibility.

The system may utilize multi-band noise reduction algorithms that may divide the audio spectrum into multiple frequency bands for independent processing. Each frequency band may be analyzed separately to determine the presence of speech or noise components. The noise reduction parameters may be adjusted independently for each band, allowing for more precise control over the filtering process and better preservation of speech characteristics across different frequency ranges.

Hardware components involved in noise filtering may include specialized microphone arrays integrated within the mobile device or connected as external accessories. The microphone array 102 may comprise multiple omnidirectional or directional microphones positioned to capture voice input from different spatial locations. Beamforming algorithms may be applied to the signals from the microphone array to enhance voice signals arriving from the user's direction while suppressing noise sources from other directions.

Digital signal processors may be incorporated within the voice interaction module 102 to perform real-time noise filtering operations. These dedicated processors may execute specialized algorithms optimized for audio signal processing, including finite impulse response filters, infinite impulse response filters, and adaptive filter implementations. The digital signal processors may operate at high sampling rates to ensure minimal latency in voice processing while maintaining high-quality noise reduction performance.

Dedicated noise cancellation circuits may be implemented using analog signal processing components that may provide initial noise reduction before digital processing. These circuits may include automatic gain control amplifiers that may adjust signal levels to optimize the dynamic range for subsequent digital processing. Low-pass and high-pass filters may be employed to remove frequency components outside the typical human speech range, reducing computational requirements for digital noise filtering algorithms.

The system may distinguish between voice signals and background noise through frequency analysis methods that may examine the spectral characteristics of the input audio. Voice activity detection algorithms may analyze the audio signal for patterns characteristic of human speech, including formant frequencies, pitch variations, and temporal speech patterns. The system may calculate spectral centroid, spectral rolloff, and zero-crossing rate parameters to differentiate between speech and non-speech audio segments.

Threshold determination algorithms may establish dynamic thresholds for voice activity detection based on the current noise environment. The system may continuously monitor the background noise level and may adjust detection thresholds accordingly to maintain consistent voice recognition performance across varying acoustic conditions. Adaptive threshold algorithms may use statistical analysis of the audio signal to determine optimal threshold values that may minimize false positive and false negative detections.

Machine learning algorithms may be trained to recognize voice patterns specific to fishing-related terminology and commands. The natural language processing module 104 may employ neural network models that may be trained on datasets containing fishing-specific vocabulary spoken in outdoor environments with various background noise conditions. These models may learn to distinguish between fishing-related speech and environmental sounds such as water movement, wind, and equipment noise.

Real-time spectral analysis may be performed using sliding window techniques that may continuously analyze short segments of the audio input. The system may calculate power spectral density estimates for each audio segment and may compare these estimates with reference noise spectra to identify and suppress noise components. The window size and overlap parameters may be optimized to balance noise reduction effectiveness with processing latency requirements.

The voice interaction module 102 may implement noise gating techniques that may automatically mute the audio input when voice activity falls below predetermined thresholds. The noise gate may prevent low-level background noise from being processed by subsequent voice recognition algorithms, reducing computational load and improving overall system performance. The gate threshold and release time parameters may be dynamically adjusted based on the current noise environment.

Multi-channel audio processing may be employed when multiple microphones are available, allowing for advanced noise reduction techniques such as coherence-based filtering. The system may analyze the coherence between signals from different microphones to distinguish between correlated voice signals and uncorrelated noise components. Signals with high coherence across multiple channels may be identified as voice signals, while low-coherence signals may be classified as noise and suppressed accordingly.

### B. a Natural Language Processing Module

In embodiments, the platform 100 may include a natural language processing module 104. The natural language processing module 104 may include hardware and/or software configured to interpret the spoken words of the user. In embodiments, the natural language processing module 104 may be integrated with or in operative connection to the voice interaction module.

The natural language processing module 104 operates as a component of the platform100 to interpret and process voice input from users. In embodiments, the input may be received (e.g., from the voice interaction module 102. For example, the input may be received during a fishing event. The natural language processing module 104 may employ advanced algorithms, including (but not limited to) Natural Language Processing and/or Natural Language Understanding algorithms to analyze spoken words and phrases, converting them into actionable data.

Natural Language Processing (NLP) is a field of artificial intelligence that focuses on the interaction between computers and human language. NLP enables computers to understand, interpret, and generate human language in a way that is both meaningful and useful. This technology is used to process and analyze large amounts of natural language data, allowing computers to perform tasks such as language translation, sentiment analysis, speech recognition, and text summarization.

In the context of the platform 100, NLP is used to process voice input from users (e.g., via the voice interaction module 102). When a user speaks a keyword, the platform may use NLP to interpret the keyword phrase and, thereafter, trigger one or more specific actions. For example, the platform 100 may drop a pin on a map to mark the location of a fishing event, retrieve relevant data from the internet, and/or log various details about the fishing event.

Natural Language Understanding (NLU) is a subfield of artificial intelligence (AI) and natural language processing (NLP) that focuses on enabling computers to comprehend and interpret human language in a meaningful way. NLU goes beyond merely recognizing words and phrases; NLU aims to understand the context, intent, and nuances of the language used by humans.

In the context of the platform 100, NLU plays a role in interpreting the voice input provided by users. When a user speaks a command or describes an event, the natural language processing module 104 may use NLU to process the input and determine the user's intent and/or extract relevant information.

The natural language understanding system architecture may comprise multiple interconnected processing layers that may work in coordination to extract semantic meaning from voice input during fishing activities. The NLU system may differ from traditional natural language processing by incorporating domain-specific knowledge about fishing terminology, equipment, and activities to provide more accurate interpretation of user commands and descriptions.

The NLU architecture may employ a hierarchical processing structure where initial speech recognition may convert audio signals into text representations. The text processing layer may apply tokenization algorithms to segment the input into discrete linguistic units. Part-of-speech tagging algorithms may classify each token according to grammatical categories such as nouns, verbs, and adjectives. Named entity recognition models may identify specific fishing-related entities including species names, equipment types, and location references.

The trigger word identification mechanism may utilize pattern matching algorithms that may compare incoming text against predefined vocabulary sets containing fishing-specific terminology. The pattern matching system may employ regular expression algorithms to identify variations and inflections of trigger words. Fuzzy matching techniques may account for speech recognition errors and dialectical variations in pronunciation. The system may maintain separate pattern libraries for different fishing contexts such as freshwater angling, saltwater fishing, and ice fishing applications.

Semantic analysis methods may extend beyond simple keyword matching to understand contextual relationships between words and phrases. Context understanding techniques may maintain conversational state information to interpret pronouns, references, and implicit information in user speech. The context management system may track previously mentioned entities such as fish species, locations, and equipment to resolve ambiguous references in subsequent utterances. Temporal context tracking may associate time-sensitive information with appropriate fishing events based on the sequence of user interactions.

The machine learning models employed for NLU may include transformer-based architectures that may process sequential text input through attention mechanisms. The attention layers may focus on relevant portions of the input sequence when making classification decisions. Training methodologies for the NLU models may incorporate active learning techniques to continuously improve performance based on user interactions.

Inference processes for the NLU system may operate in real-time to provide immediate response to user voice input. The inference pipeline may employ model quantization techniques to reduce computational requirements for mobile device deployment. Batch processing capabilities may allow the system to process multiple utterances simultaneously when computational resources permit. The inference system may implement caching mechanisms to store frequently accessed model parameters and intermediate results.

Intent recognition algorithms may classify user utterances according to predefined intent categories such as event logging, note taking, or system commands. Entity extraction processes may identify and classify specific information elements within user speech such as fish species, sizes, locations, and equipment details. Named entity recognition models may be trained to recognize fishing-specific entity types that may not be present in general-purpose NER systems. The entity extraction system may employ sequence labeling algorithms to identify entity boundaries within continuous text. Post-processing rules may validate extracted entities against known databases of fish species, equipment types, and geographic locations.

Confidence scoring mechanisms may provide quantitative measures of system certainty for each processing step in the NLU pipeline. The confidence scoring system may combine multiple sources of uncertainty including speech recognition confidence, semantic parsing confidence, and intent classification confidence. Threshold-based decision making may determine when system confidence may be sufficient to proceed with automated actions versus when user confirmation may be required. The confidence scores may be calibrated through validation on held-out test datasets to ensure accurate probability estimates.

The NLU system may integrate with the broader NLP processing pipeline through standardized interfaces that may allow modular replacement of individual components.

NLP and/or NLU may involve one or more processes or techniques, including (but not limited to):
1. Tokenization: This process involves breaking down a stream of text or speech into individual words or tokens. For example, the sentence “Fish on, the fish is a large one!” would be tokenized into [“Fish”, “on”, “,”, “the fish is”, “a”, “large”, “one”, “!”].
2. Part-of-Speech Tagging: This technique assigns parts of speech (such as nouns, verbs, adjectives) to each token. For example, in the phrase “fish on,” “fish” would be tagged as a noun.
3. Named Entity Recognition (NER): NER identifies and classifies named entities in text into predefined categories such as names of people, organizations, locations, dates, etc. For instance, in the sentence “Caught a trout at Lake Erie,” “Lake Erie” would be recognized as a location.
4. Parsing: This process involves analyzing the grammatical structure of a sentence to understand the relationships between words. This helps in understanding the context and meaning of the sentence.
5. Sentiment Analysis: This technique determines the sentiment or emotion expressed in a piece of text. For example, the technique can identify whether a review is positive, negative, or neutral.
6. Speech Recognition: This process converts spoken language into text. This component is used for applications that rely on voice input, such as the sport fishing data collection app.

By leveraging these techniques, NLP and/or NLU allows the natural language processing module 104 to accurately interpret the spoken words of the user, even in environments with background noise typical of outdoor settings. This capability enhances the user experience by enabling hands-free data collection and minimizing the need for manual input during fishing activities.

The natural language processing module 104 may continuously monitor the voice input for specific keywords and phrases that are predefined within the system. Upon detecting these keywords, the natural language processing module 104 (and/or the voice interaction module 102) may trigger one or more corresponding actions within the platform 100, such as (but not limited to) logging the event, dropping a pin on a map, and/or retrieving relevant data from the internet.

The machine learning model training process may be tailored for fishing-specific vocabulary and speech patterns. The model may employ a comprehensive multi-stage approach that may integrate domain-specific data collection, advanced preprocessing techniques, and specialized neural network architectures. The training data collection methodology may begin with the systematic gathering of fishing-related audio samples from diverse sources to ensure comprehensive coverage of fishing terminology and speech patterns across different regional dialects and fishing contexts.

Training data collection may involve recording fishing-related conversations and commands from experienced anglers across multiple geographic regions to capture regional variations in fishing terminology and pronunciation patterns. The training dataset may be augmented through partnerships with fishing guides, charter boat operators, and fishing tournament organizations to obtain diverse samples of fishing-related speech from professional and recreational anglers. Audio samples may be collected from fishing instructional videos, podcasts, and educational content to expand the vocabulary coverage and include technical fishing terminology.

Data preprocessing techniques may include advanced audio signal processing methods to normalize audio quality and remove unwanted artifacts while preserving speech characteristics essential for accurate recognition. The preprocessing stage may employ voice activity detection algorithms to segment continuous audio streams into discrete speech utterances containing fishing-related content. Silence removal and endpoint detection techniques may eliminate non-speech portions of audio recordings while preserving natural speech timing and prosodic features. The preprocessing system may apply spectral subtraction and/or Wiener filtering techniques to enhance speech signals degraded by environmental noise common in fishing scenarios.

Dataset preparation procedures may involve the systematic annotation and labeling of audio samples with corresponding transcriptions and semantic tags identifying specific fishing concepts, equipment types, and activity descriptions. The dataset preparation methodology may implement stratified sampling techniques to ensure balanced representation of different fishing contexts, including freshwater and saltwater fishing, various fishing methods such as fly fishing and trolling, and diverse species-specific terminology. The training dataset may be partitioned into training, validation, and test sets using temporal and speaker-independent splits to evaluate model generalization capabilities across different users and time periods.

Neural network architectures employed for fishing-specific speech recognition may include transformer-based models that may leverage attention mechanisms to focus on relevant portions of audio input when processing fishing-related commands and descriptions. The model architecture may incorporate convolutional neural network layers for acoustic feature extraction combined with recurrent neural network components for temporal sequence modeling of speech patterns. Deep learning models may utilize residual connections and batch normalization techniques to facilitate training of deep network architectures capable of learning complex fishing vocabulary patterns.

Training optimization methods may utilize distributed computing approaches to accelerate model training across multiple graphics processing units or tensor processing units. The optimization process may implement gradient accumulation techniques to simulate larger batch sizes when hardware memory constraints limit batch size selection. Mixed precision training methods may be employed to reduce memory requirements and accelerate training while maintaining numerical stability and model accuracy.

Fishing terminology variation handling may employ semantic embedding techniques that may map related fishing terms to similar vector representations in high-dimensional space. The system may implement synonym detection and expansion mechanisms that may recognize alternative terms for the same fishing concepts or equipment types. Contextual understanding capabilities may enable the model to disambiguate fishing terms that may have multiple meanings depending on the fishing context or geographic region.

Transfer learning approaches may leverage pre-trained speech recognition models developed on large-scale general speech datasets as initialization for fishing-specific model training. The transfer learning methodology may employ progressive unfreezing techniques where different layers of the pre-trained model may be gradually adapted to fishing-specific vocabulary and acoustic patterns. Domain adaptation techniques may fine-tune general-purpose language models on fishing-specific text corpora to improve understanding of fishing terminology and context.

Cross-lingual transfer learning methods may be employed to leverage fishing terminology and speech patterns from multiple languages to improve model performance in multilingual fishing environments. The transfer learning approach may utilize knowledge distillation techniques where larger teacher models may guide the training of smaller student models optimized for mobile device deployment. Meta-learning approaches may enable rapid adaptation to new fishing terminology or regional dialects with minimal additional training data.

Model validation procedures may employ cross-validation techniques that may evaluate model performance across different speakers, fishing contexts, and acoustic conditions. Performance metrics may include word error rate measurements specifically calculated on fishing-related vocabulary to assess transcription accuracy for domain-specific terms. Intent classification accuracy metrics may evaluate the model's ability to correctly identify fishing-related commands and requests. Entity extraction performance may be measured using precision, recall, and F1-score metrics for fishing-specific entities such as species names, equipment types, and location references.

Continuous learning mechanisms may implement online learning algorithms that may update model parameters based on user feedback and correction data collected during system operation. The continuous learning system may employ active learning techniques that may identify uncertain predictions and request user confirmation to improve model accuracy over time.

Model updating procedures may implement automated retraining pipelines that may periodically update model parameters using newly collected training data and user feedback. The model updating methodology may implement federated learning approaches that may enable collaborative model improvement across multiple users while preserving individual privacy and data security.

The natural language processing module 104 may support real-time or near real-time processing, allowing the platform 100 to respond substantially immediately to the user's commands. This real-time capability helps to ensure that the data provided by a user or another component of the platform 100 is logged accurately and promptly, providing a seamless and efficient user experience. By leveraging state-of-the-art NLP and NLU technologies, the natural language processing module 104 significantly reduces the need for manual data entry, allowing users to focus on their other activities without interruption.

Spectral subtraction techniques may be implemented within the natural language processing module 104 to remove background noise from voice recordings. The spectral subtraction algorithm may analyze the frequency spectrum of the input audio signal and may identify noise components by comparing the current spectrum with a noise reference spectrum captured during periods of silence. The system may subtract the estimated noise spectrum from the voice signal spectrum to produce a cleaned audio signal with enhanced speech clarity.

### C. an Event Logging Module

In embodiments, the platform 100 may include an event logging module 106. The event logging module 106 may include hardware and/or software configured to log events, such as fishing events (e.g., hooking, fighting, losing, landing, returning, and/or harvesting a fish) or other events (e.g., notes), by dropping pins on a map, retrieving data from the internet, and/or tabulating statistical data related to each event.

The event logging module 106 may be triggered in response to identification of a keyword spoken by a user (e.g., via the voice interaction module 102 and/or the natural language processing module 104). Triggering the event logging module 106 may cause the platform 100 to initiate actions such as dropping pins on a map to mark the precise location of the event, retrieving relevant data from one or more outside sources, and/or logging detailed information about the event.

Dropping a pin on a map may comprise retrieving geolocation data, via a global positioning system (GPS) unit integrated into and/or operatively connected to the device on which the platform 100 is operating (e.g., a smartphone, tablet computer, etc.). Retrieving the geolocation data may involve a satellite connection with a GPS satellite, and may not be dependent on the device receiving a cellular communication signal. The retrieved geolocation data may be used to position the pin on a map, indicating the location of the event.

Retrieving relevant data from one or more outside sources may include retrieving weather condition, water condition, and/or timestamp data from one or more of an external data collection device (DCD) in communication with the device on which the platform 100 is operating (e.g., via the integration module 108). Additionally or alternatively, the relevant data may be retrieved from a third-party data repository accessible via the internet.

In some embodiments, the relevant data may be retrieved in real-time or substantially in real-time (e.g., immediately following the triggering of the event logging module 106). Additionally of alternatively, a timestamp and geolocation may be determined in real time, and additional relevant data may be retrieved at a later time based at least in part on the timestamp and/or the geolocation.

The event logging module 106 may use a transcript of the user speech (e.g., from the voice interaction module 102 and/or the natural language processing module 104) to determine additional information related to the event. For example, in response to a fishing event (e.g., via the keyword “fish on”), the event logging module 106 may refer to the transcript to determine details about the fishing event (e.g., the fisher related to the event, the species of fish, the size of the fish, a fishing method used, a tackle used, and/or any other information spoken by the user) to provide a more comprehensive record of each fishing event.

As another example, in response to a non-fishing event (e.g., via the keyword “take a note”), the event logging module 106 may include a portion of the transcript of the user speech in the note. The portion of the transcript may have a predetermined duration set by the platform 100 and/or the user (e.g., 30 seconds, 60 seconds, etc.), or may have a variable duration (e.g., until a user stops speaking for a set amount of time (e.g., 3 seconds).

The event logging module 106 may integrate seamlessly with other components of the platform 100, such as the natural language processing module 104 and the voice interaction module 102, to help ensure accurate and real-time data collection. By leveraging advanced algorithms, the event logging module 106 can interpret the user's spoken words and automatically log the corresponding events without requiring manual input. This hands-free approach enhances the user experience by allowing the angler to focus on fishing activities while the platform autonomously records relevant data.

The data compilation module 110 may implement sophisticated computational methods for generating comprehensive summary statistics within the electronic logbook system. The statistical computation engine may employ real-time aggregation algorithms that may process incoming fishing event data to calculate metrics such as total fish caught, trip duration, average catch size, and success rates. These calculations may be performed using mathematical formulas that may account for temporal variations and species-specific parameters to provide accurate statistical representations of fishing performance.

The total fish caught calculation may utilize a summation algorithm that may increment counters for each logged fishing event based on the outcome classification determined by the natural language processing module 104. The system may maintain separate counters for different event types, including fish hooked, fish landed, fish released, and fish harvested. The mathematical implementation may employ integer arithmetic operations where each successful fish landing event may increment the total catch counter by one unit. The algorithm may also track species-specific totals by maintaining associative arrays that may map species identifiers to corresponding count values.

Trip duration calculations may be implemented through timestamp differential analysis algorithms that may compute elapsed time between trip initiation and conclusion events. The system may record high-precision timestamps using coordinated universal time standards to ensure accurate temporal measurements across different time zones and daylight saving transitions. The duration calculation may employ subtraction operations on timestamp values, with results converted to human-readable formats such as hours, minutes, and seconds. The algorithm may account for potential interruptions or pauses in fishing activities by analyzing gaps in event logging patterns.

Average catch size computations may utilize statistical mean calculation algorithms that may process size measurements collected during fishing events. The system may maintain running totals of fish size measurements along with count values to enable efficient mean calculation without requiring storage of individual measurement values. The mathematical implementation may employ floating-point arithmetic to preserve measurement precision, with size values typically recorded in length (e.g., inches or centimeters) and/or weight (e.g., ounces, kilograms, etc.) depending on user preferences. The algorithm may handle missing size data through interpolation methods or exclusion from average calculations based on configurable parameters.

Success rate calculations may be implemented using ratio analysis algorithms that may compare successful fishing outcomes against total fishing attempts. The system may define success metrics based on various criteria, including hook-to-land ratios, species-specific success rates, and time-based performance indicators. The mathematical formulas may calculate percentages by dividing successful event counts by total event counts and multiplying by one hundred. The algorithm may provide confidence intervals for success rate estimates using statistical methods such as binomial proportion confidence intervals.

The data processing workflow may implement multi-stage validation procedures to ensure statistical accuracy and data integrity. Input validation algorithms may verify that incoming data values fall within expected ranges and conform to predefined data type specifications. The system may employ range checking for numerical values such as fish sizes and weights, ensuring that measurements are physically reasonable and consistent with known species characteristics. Temporal validation may verify that event timestamps follow logical sequences and fall within reasonable time boundaries for fishing activities.

Data aggregation methods may utilize efficient data structure management techniques to optimize statistical computation performance. The system may employ hash tables and binary search trees to organize fishing event data for rapid retrieval and processing. Aggregation algorithms may process data in batches to minimize computational overhead while maintaining real-time responsiveness for user interactions. The implementation may use memory-efficient data structures that may minimize storage requirements while preserving statistical accuracy.

Real-time calculation updates may be implemented through event-driven processing architectures that may trigger statistical recalculations upon receipt of new fishing event data. The system may employ incremental update algorithms that may modify existing statistical values rather than recalculating entire datasets. This approach may significantly reduce computational requirements for large datasets while maintaining statistical accuracy. The update mechanisms may utilize atomic operations to ensure data consistency during concurrent access scenarios.

Database operations for statistical computation may employ optimized query structures that may minimize data retrieval overhead. The system may utilize indexed database tables that may enable rapid access to fishing event records based on temporal, spatial, and categorical criteria. Query optimization techniques may include the use of prepared statements, connection pooling, and result caching to improve database performance. The database schema may be designed to support efficient aggregation operations through denormalized data structures where appropriate.

Query optimization may be implemented through intelligent caching mechanisms that may store frequently accessed statistical results in high-speed memory systems. The caching algorithms may employ least-recently-used eviction policies to manage memory utilization while maximizing cache hit rates. Cache invalidation strategies may ensure that statistical results remain current when underlying data changes. The system may utilize distributed caching architectures to support scalable performance across multiple computing nodes.

Data structure management for efficient statistics computation may employ specialized data structures optimized for statistical operations. The system may utilize streaming data structures such as count-min sketches and HyperLogLog algorithms for approximate statistical calculations on large datasets. These probabilistic data structures may provide memory-efficient alternatives to exact calculations while maintaining acceptable accuracy levels for most statistical applications.

Statistical accuracy may be maintained through precision handling mechanisms that may account for floating-point arithmetic limitations and rounding errors. The system may employ decimal arithmetic libraries for financial calculations and measurements requiring high precision. Error propagation analysis may be implemented to quantify the cumulative effects of measurement uncertainties on derived statistical values. The algorithms may provide confidence bounds for statistical estimates based on input data quality assessments.

Error correction mechanisms may be implemented through anomaly detection algorithms that may identify and flag potentially erroneous data values. The system may employ statistical outlier detection methods such as z-score analysis and interquartile range filtering to identify measurements that deviate significantly from expected patterns. Machine learning algorithms may be trained to recognize common data entry errors and suggest corrections based on historical patterns and contextual information.

The statistical computation system may implement robust error handling procedures that may gracefully manage exceptional conditions such as missing data, invalid measurements, and system failures. Fallback algorithms may provide alternative calculation methods when primary statistical procedures encounter errors. The system may maintain audit trails of statistical calculations to enable debugging and verification of computational results.

### D. an Integration Module

In embodiments, the platform 100 may include an integration module 108. The integration module 108 may include hardware and/or software configured to interact with (e.g., retrieve data from) one or more external data collection devices (DCDs) to enhance a data set related to an event logged by the event logger module 106. In embodiments, the DCDs may including (but need not be limited to) devices such as stream or water thermometers, depth gauges, thermometers, cameras, drones, and/or any other DCDs. In some embodiments, the DCDs may be personal devices. In other embodiments, one or more of the DCDs may be embodied as (or be in communication with) publicly-accessible data sources, such as (but not limited to) United States Geological Survey (USGS) stream gauges or National Oceanic and Atmospheric Administration (NOAA) buoys.

The integration module 108 facilitates the interaction between the mobile application and external DCDs to enhance the dataset related to logged events. The integration module 108 establishes communication with various DCDs using wired and/or wireless communication protocols, such as Bluetooth, ZigBee, Near Field Communication, Radio Frequency communication, cellular communication, and/or any other appropriate and supported communication method. This connectivity allows the platform 100 to retrieve additional environmental parameters, including water temperature, depth, and other relevant data, in real-time and/or at predefined intervals.

Upon establishing a connection with a DCD, the integration module 108 may monitor and collect data from the DCD. The collected data may be synchronized with a corresponding event logged by the event logging module 106. This synchronization helps to ensure that the environmental data is accurately associated with the specific time and geolocation of the event, providing a comprehensive and detailed record. The integration module 108 may support the configuration and/or calibration of one or more connected DCDs, allowing a user to set preferences and thresholds for data collection, helping to ensure that the retrieved data meets the specific requirements of the fishing activity and/or any logged event.

The integration module 108 enhances the overall functionality of the platform 100 by enabling seamless data acquisition from one or more DCD sources. This capability not only enriches the dataset but also provides users with insights into the environmental conditions that may influence fishing success. By integrating data from external devices, the module contributes to a more accurate and informative electronic logbook, aiding users in analyzing patterns and making data-driven decisions for future fishing trips. Moreover, the ability to interface with external DCDs allows for streamlined design of sensors included within the platform 100 and enables the user to use any preferred DCD equipment.

### E. a Data Compilation Module

In embodiments, the platform 100 may include a data compilation module 110. The data compilation module 110 may include hardware and/or software configured to compile multiple data points into an electronic logbook.

The data compilation module 110 may aggregate and organize multiple data points into a cohesive electronic logbook. The compilation module 110 receives input from various other modules, including (without limitation) the event logging module106, the integration module 108, and/or the internet service module 118, to compile a comprehensive record of each fishing event. The data points collected and organized at the compilation module 110 may encompass GPS coordinates, fishing information (e.g., species, size, fishing method, tackle used, etc.), weather conditions, water conditions, timestamps, user notes, and/or any other data. By integrating these diverse data points, the data compilation module 110 helps to ensure that the logbook provides a detailed and accurate representation of each event.

Upon receiving data from the event logging module 106, the data compilation module 110 may process and structure the data into a timeline format and/or a map format. These formats may allow for various presentations of the data to users (e.g., via the display module 120). In some embodiments, where the data received from the event logging module 106 is incomplete, the compilation module 110 may include blank values for these data points. Alternatively, the compilation module may include default values based at least in part on user preference, geolocation, and/or time of year. For example, when a user is fishing in an area where walleye are plentiful (e.g., Lake Erie), if the user omits the species of a caught fish, the data compilation module may insert a default species of walleye.

The data compilation module may calculate summary statistics, such as the total number of fish caught, the total number of fish of each species caught, the duration of each event, and the overall length of the trip, providing users with insights into their fishing performance.

In some embodiments, the data compilation module may compare the summary statistics to one or more state, local, and/or federal wildlife regulations, allowing the user to determine whether they are approaching limits on harvesting fish generally or a particular species of fish. This may aid users in avoiding penalties for overfishing.

In some embodiments, the data compilation module 110 may incorporate photos and/or videos tagged to specific events based on time, proximity, and/or location (e.g., via the photo integration module 114). This feature allows users to visually document their catches and/or other notable moments during the trip. The compiled data is then stored (e.g., via the cloud storage system 116), helping to ensure secure and accessible data management.

### F. a User Profile and Preferences Module

In embodiments, the platform 100 may include a user profile and preferences module 112. The user profile and preferences module 112 may include hardware and/or software configured to allows users to set up profiles and preferences. In some embodiments, the user profile and preferences module 112 may allow professional guides to establish a profile that permits separate tracking of personal fishing activities and client fishing activities.

The user profile and preferences module 112 may allow a user to set up and manage a profile and preferences within the platform 100. The module 112 may enable a user to input personal information including, but not limited to, name, contact details, and fishing preferences (e.g., preferred fishing style, preferred tackle, etc.). The platform uses the provided information to tailor the user experience. In embodiments, a user can specify their preferred fishing methods, target species, and favorite fishing locations, allowing the platform 100 to provide personalized recommendations and data logging options. The module 112 may support customization of notification settings, enabling users to choose how they receive alerts and updates during fishing events.

For professional fishing guides, the user profile and preferences module 112 includes additional features to allow the user to separately track personal fishing activities and client fishing activities. Professional users can toggle between personal and business modes, allowing the professional user to maintain separate records for their own fishing trips and those conducted with clients. The module 112 may provide options to input client information, such as names and contact details, and to log client-specific fishing data. This functionality ensures that professional guides can efficiently manage their business operations while keeping their personal fishing data distinct. In some embodiments, e.g., where the client has an account with the platform 100), this functionality may allow a client to access data recorded on their behalf by a professional guide.

The user profile and preferences module 112 may include privacy settings, allowing users to control the visibility of their fishing data. Users can choose to keep specific fishing spots (e.g., particular geolocations) private, ensuring that sensitive location information is not shared with others. The module 112 provides options for users to share aggregated data for broader analysis while maintaining the confidentiality of their personal fishing locations. This balance between data sharing and privacy encourages user participation.

### G. a Photo Integration Module

In embodiments, the platform 100 may include a photo integration module 114. The photo integration module 114 may include hardware and/or software configured to allow a user to tag photos and/or videos taken during a trip to tie the photos and/or videos to specific events within the trip based on one or more of time, proximity, and/or location.

The photo integration module may allow users to tag photos and/or videos taken during a fishing trip to specific events within the trip. This module ensures that visual media captured during the fishing event is accurately associated with relevant data points, such as the time, location, and details of the catch. The photo integration module 114 compares metadata from a photo/video (e.g., timestamps and/or GPS coordinates), to match the media with corresponding events logged by the event logging module. For example, a photo or video may be tagged to correspond to the event having a timestamp that immediately precedes a timestamp in the photo metadata (e.g., the event that occurred in most recent history, compared to the timestamp of the photo). As another example, a series of events recorded during a trip may indicate a general direction of travel during the trip; a photo may be tagged to an event by selecting a geolocation of an event nearest to the geolocation of the photo or video, opposite the general direction of travel.

Following capture of a photo or video, the photo integration module 114 may retrieve the metadata associated with the photo and cross-reference the metadata with the compiled timeline and/or map data (e.g., compiled by the data compilation module 110). This process ensures that each photo or video is linked to the appropriate event, providing a visual record that complements the textual and numerical data. The module 114 supports various media formats and can handle multiple photos and/or videos for a single event, allowing users to document their experiences comprehensively.

The photo integration module 114 may include features for organizing and displaying the tagged media within the electronic logbook (e.g., via the display module 120). Users can view a gallery of images and videos associated with one or more fishing trips concurrently, with options to filter and sort the media based on criteria such as date, location, event type, media type, fish species, and/or any other useful filtering criteria.

The photo integration module 114 may allow a user to add captions and notes to the tagged media, further enriching the documentation of the fishing trip. These annotations may include details about the catch, such as species, size, and tackle used, details as well as personal observations and comments. The module ensures that all media and annotations are securely stored in the cloud storage system, providing easy access and retrieval for future reference and analysis.

### H. a Cloud Storage System

In embodiments, the platform 100 may include a cloud storage system 116. The cloud storage system 116 may include hardware and/or software configured to store the collected data for easy access and retrieval.

The cloud storage system 116 stores the collected data (e.g., from the data compilation module 110, photo integration module114, etc.) for access and retrieval. The cloud storage system 116 helps to ensure that all data points are securely stored in a centralized location. The cloud storage system 116 may provide users with the flexibility to access their data from any device with internet connectivity, enhancing the overall user experience by offering seamless data management and retrieval. In some embodiments, the cloud storage system 116 may encrypt stored data to prevent access by unauthorized users. Additionally or alternatively, the cloud storage data may secure data behind an identity verification requirement (e.g., entering a username and password or other authentication credentials associated with the platform 100).

The cloud storage system 116 may store integrated data from various sources, including external data collection devices (DCDs) and internet-based data repositories, as well as data generated by the platform (e.g., the electronic logbook data produced by the data compilation module 110, transcript data produced by the voice interaction module 102 and/or the natural language processing module 104), photo and/or video data produced by a camera, and/or any other data that a user may wish to review as part of the electronic log of the trip. This integration allows for a comprehensive and detailed logbook. In some embodiments, the cloud storage system 116 may facilitate the synchronization of data across multiple devices, ensuring that users have the most up-to-date information available at all times.

Security measures within the cloud storage system 116 protect user data from unauthorized access and potential data breaches. Encryption protocols and secure access controls ensure that sensitive information, such as specific fishing spots, remains private, while still allowing other users to view aggregate data that does not identify private information. Users can manage their privacy settings to control the visibility of their data, allowing for the sharing of aggregated data for broader analysis while maintaining the confidentiality of private data, such as (but not limited to) personal fishing locations.

### I. an Internet Service Module

In embodiments, the platform 100 may include an internet service module 118. The internet service module 118 may include hardware and/or software configured to retrieve data such as weather conditions, water conditions, moon phase, barometric pressure, and/or any other data related to a particular fishing excursion for each trip and/or for each event recorded during a trip (e.g., each dropped pin).

The internet service module 118 facilitates the retrieval of external data relevant to logged events. The module 119 connects to various data sources via the internet to gather information such as (but not limited to) real-time (e.g., moment-to-moment) weather conditions, moon phases, barometric pressure, and other environmental factors at the time of a particular event. By integrating this data, the internet service module 118 enhances the accuracy and comprehensiveness of the logged events. In some embodiments, the internet service module 118 may operate continuously in the background, ensuring that the most current and relevant data is available for each event logged by the platform as the event is logged. Alternatively, the internet service module may retrieve the data at a later time, based on the geolocation and timestamp information associated with the event.

As one example, weather conditions may be retrieved from one or more databases storing weather data, such as databases maintained by the National Weather Service and/or other third-party databases. As another example, water conditions can be gathered via USGS stream gauges and/or National Oceanic and Atmospheric Administration (NOAA) buoys.

In some embodiments, the internet service module 118 may initiate a data retrieval process in response to detecting a keyword spoken by the user. This process may involve querying one or more online databases using one or more APIs to collect specified information. The internet service module 118 may process and/or format the retrieved data to help ensure compatibility with a data structure used by the platform 100. This processed and/or formatted data may subsequently be integrated into the electronic logbook, providing users with a detailed and enriched record of their activities.

The internet service module 118 may support or facilitate the synchronization of data across multiple devices (e.g., by facilitating upload of electronic logbook data to the cloud storage system 116. This synchronization capability allows users to seamlessly switch between devices without losing any information.

In some embodiments, the internet service module 118 may employ one or more secure communication protocols to protect the integrity and confidentiality of data during transmission (e.g., during retrieval of data from various internet sources and/or transmission of the data to the cloud storage system 116).

### J. a Display Module

In embodiments, the platform 100 may include a display module 120. The display module 120 comprises hardware and software elements configured to present information in a user-friendly and intuitive manner.

The display module 120 may provide users with a visual interface to access and interact with the electronic logbook and other data collected during fishing events. The module 120 supports various display formats, including timelines, maps, and summary statistics, allowing users to view their fishing data in multiple contexts. The display module 120 may integrate seamlessly with other platform components, such as the data compilation module 110 and the photo integration module 114, to ensure that all relevant data points are accurately represented and easily accessible.

The display module 120 may enable users to navigate through their fishing logbook, view detailed records of individual logged events, and analyze patterns and trends over time. The module 120 may support interactive features, such as zooming in on specific map locations, filtering data based on criteria such as date, species, and/or fishing method, and accessing detailed information about each logged event. The display module 120 may allow a user to view photos and/or videos tagged to specific logged events, providing a comprehensive visual record of the fishing experiences. By offering a dynamic and interactive interface, the display module 120 enhances the overall user experience and facilitates efficient data management and analysis.

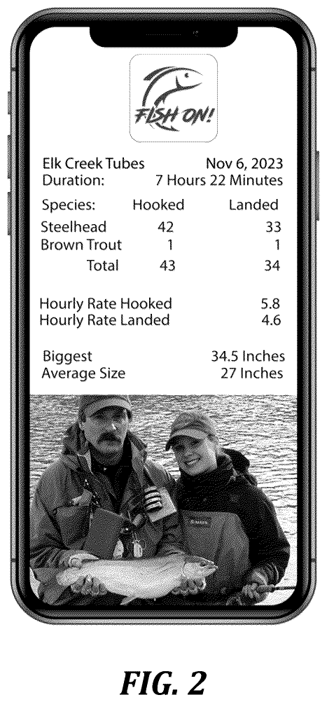

As shown in FIG. 2, the display module 120 may provide a first visual interface to users viewing an electronic logbook using a mobile device, such as a smartphone. FIG. 2 shows a screenshot of a smartphone interface for displaying the electronic logbook. The top section of the interface displays the location “Elk Creek-Tubes” and the date “Nov. 6, 2023.” The duration of the fishing event is recorded as “7 Hours 22 Minutes.”

The middle section of the interface provides detailed statistics about the fishing event. The interface lists the species of fish, the number of fish hooked, and the number of fish landed. Specifically, the interface shows that 42 Steelhead were hooked and 33 were landed, while 1 Brown Trout was both hooked and landed. The total number of fish hooked is 43, and the total number of fish landed is 34. The hourly rate of fish hooked is 5.8, and the hourly rate of fish landed is 4.6. For the specific event being shown, the fish caught is recorded as 34.5 inches, and the average size of the fish is 27 inches.

The bottom section of the interface features a photograph related to the fishing event. The photograph shows two individuals holding a fish, providing a visual record of the catch. This image is tagged to the specific fishing event, enhancing the documentation of the fishing experience.

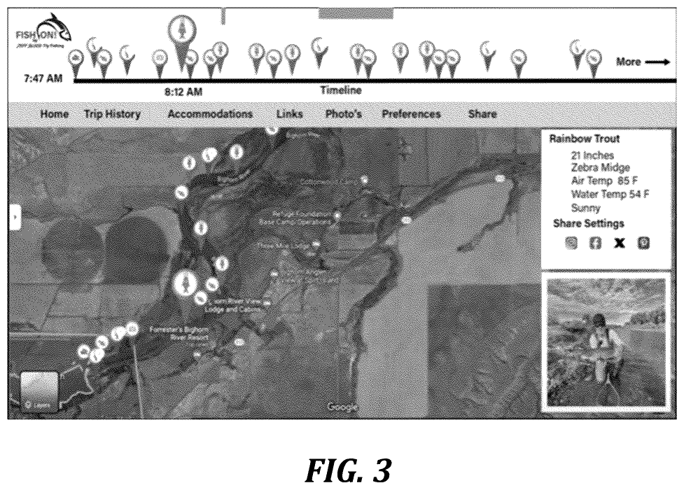

As shown in FIG. 3, the display module may provide a second user interface to users viewing an electronic logbook using a desktop computer or tablet computer having a larger or higher-resolution screen, when compared to that of a smartphone. The interface is designed to provide users with a comprehensive view of their fishing activities, including detailed event logs, environmental data, and visual records.

The top section of the interface features a timeline. This timeline includes various icons representing different events and activities that occurred during the fishing trip. Each icon corresponds to a specific event, such as catching a fish, taking a note, or marking a point of interest. The icons are color-coded and labeled to indicate the type of event they represent.

Below the timeline, a navigation bar provides access to different sections of the platform, including “Home,” “Trip History,” “Accommodations,” “Links,” “Photo's,” “Preferences,” and “Share.” This navigation bar allows users to easily switch between different views and functionalities within the platform.

The main section of the interface displays a map view of the fishing area, which in this case is centered around the Bighorn River. The map includes various pins and icons that mark specific locations and events recorded during the fishing trip. These pins are color-coded and labeled to indicate different types of events, such as fishing spots, accommodations, and points of interest. The map provides a visual representation of the user's fishing activities and helps to contextualize the data collected during the trip.

On the right side of the interface, a detailed event log is displayed. This log provides specific information about a particular fishing event, in this case, the catching of a Rainbow Trout. The log includes details such as the fish species (Rainbow Trout), size (21 inches), bait used (Zebra Midge), air temperature (85° F.), water temperature (54° F.), and weather conditions (Sunny). This detailed log helps users to keep track of important information related to their fishing activities.

Below the event log, a photo of the fishing event is displayed. The photo shows an individual holding the caught Rainbow Trout, providing a visual record of the catch. This photo is tagged to the specific event and enhances the documentation of the fishing experience.

The interface also includes options for sharing the event log and photo on social media platforms such as Instagram, Facebook, Twitter, and Pinterest. This sharing functionality allows users to easily share their fishing experiences with friends and followers.

### K. Alternative Embodiments

The platform may support alternative embodiments that extend beyond the primary voice-activated data collection system while maintaining the core functionality of hands-free fishing event documentation. Alternative implementations may provide users with multiple interaction modalities and enhanced data collection capabilities that accommodate diverse fishing scenarios and user preferences.

An alternative embodiment may incorporate gesture-based control systems that complement the voice interaction capabilities. The system may utilize camera sensors integrated into mobile devices to detect specific hand gestures that correspond to fishing events. Users may perform predefined gestures such as raising a fist to indicate a fish strike or making a circular motion to mark a point of interest. The gesture recognition module may employ computer vision algorithms to interpret these movements and trigger appropriate data collection sequences. This embodiment may prove particularly useful in environments where voice commands may not be practical due to noise restrictions or when fishing in groups where verbal communication may interfere with others'experiences.

The platform may implement an alternative embodiment utilizing wearable device integration for enhanced data collection and user interaction. A companion application for use with the wearable device may provide haptic feedback through vibration patterns that correspond to different fishing events and system notifications. The wearable device may include dedicated physical buttons that users may press to trigger specific actions such as marking fish strikes, logging catches, or dropping location pins. The device sensors may include accelerometers and gyroscopes that detect body or arm movements associated with casting, reeling, and fish fighting activities. This wearable embodiment may provide users with discreet interaction capabilities that do not require handling of the primary mobile device during fishing activities.

An alternative implementation may feature automated environmental monitoring through integration with Internet of Things sensors deployed at fishing locations. The system may communicate with permanently installed weather stations, water quality monitors, and fish activity sensors that provide continuous environmental data streams. These fixed sensor installations may transmit real-time data about water temperature fluctuations, fish movement patterns, and feeding activity indicators to the platform. The system may correlate this environmental data with user fishing activities to provide enhanced insights into optimal fishing conditions and timing recommendations.

The platform may support an alternative embodiment that incorporates drone technology for aerial fishing area surveillance and data collection. Integrated drone systems may provide overhead photography and videography of fishing areas, capturing visual documentation of fishing activities from elevated perspectives. The drone may be equipped with thermal imaging cameras that detect fish populations and movement patterns beneath the water surface. GPS-enabled drones may automatically follow users along fishing routes, providing continuous aerial documentation without requiring manual piloting. The drone data may be synchronized with ground-level fishing events to create comprehensive multi-perspective documentation of fishing experiences.

An alternative embodiment may implement underwater camera systems that provide submerged visual documentation of fishing activities. Waterproof camera devices may be deployed on fishing lines or positioned strategically in fishing areas to capture underwater footage of fish behavior and strike events. These underwater cameras may include motion detection capabilities that automatically begin recording when fish activity is detected in the camera's field of view. The underwater footage may be automatically synchronized with surface-level fishing events based on timestamp correlation and GPS positioning data.

The system may provide an alternative embodiment featuring augmented reality capabilities that overlay digital information onto real-world fishing environments. Users may view their mobile device cameras to see augmented reality displays that show historical fishing data, optimal casting locations, and real-time environmental information superimposed on the actual fishing area. The augmented reality interface may display virtual markers indicating where successful catches occurred during previous fishing trips. Users may interact with augmented reality elements through touch gestures on the mobile device screen to access detailed information about specific locations or fishing events.

An alternative implementation may incorporate social collaboration features that enable multiple anglers to contribute to shared fishing experiences and data collection. Group fishing trips may utilize a collaborative mode where multiple users'devices contribute data to a single shared fishing log. The system may automatically detect when multiple platform users are in proximity to each other and offer to merge their individual data streams into a collaborative fishing session. Each participant may contribute voice commands, photographs, and environmental data that becomes part of the shared fishing experience documentation.

The platform may support an alternative embodiment that provides offline functionality for fishing in remote areas without internet connectivity. The system may pre-download environmental data, maps, and reference information for specific fishing areas before trips begin. Offline mode may cache voice recognition models and natural language processing capabilities locally on the mobile device to ensure continued functionality without internet access. When internet connectivity is restored, the system may synchronize all offline-collected data with cloud storage systems and retrieve any missed environmental data based on timestamps and GPS coordinates.

An alternative embodiment may implement predictive analytics capabilities that provide proactive fishing recommendations based on accumulated data patterns. The system may analyze historical fishing success rates in correlation with environmental conditions, seasonal patterns, and time-of-day factors to generate probability scores for fishing success. Predictive models may recommend optimal fishing locations, tackle selections, and timing based on current environmental conditions compared to historical success patterns. The predictive system may send proactive notifications to users when conditions are favorable for fishing based on their historical preferences and success patterns.

The platform may provide an alternative implementation featuring integration with fish finder and sonar equipment commonly used by anglers. The system may connect to fish finder devices via wireless communication protocols to automatically import underwater topography data, fish location information, and water depth measurements. Sonar data may be correlated with fishing events to provide detailed information about underwater conditions at the time of each catch. The integration may include automatic detection of fish targets on sonar displays, triggering data collection sequences when fish are detected in the vicinity of fishing lines.

An alternative embodiment may incorporate biometric monitoring capabilities that track angler physiological responses during fishing activities. Heart rate monitors, stress sensors, and activity trackers may provide data about the angler's physical and emotional state during different fishing events. The system may correlate physiological data with fishing success rates to identify patterns between angler stress levels and fishing performance. Biometric data may be used to automatically detect high-intensity fishing moments such as fish strikes based on elevated heart rate and stress responses.

The platform may support an alternative implementation that provides multi-language voice recognition capabilities for international users and diverse fishing communities. The natural language processing system may support voice commands in multiple languages, allowing users to interact with the platform in their preferred language. Multi-language support may include recognition of regional fishing terminology and colloquialisms specific to different geographic areas and fishing cultures. The system may automatically detect the user's language preference based on their initial voice input and adapt the interface accordingly.

An alternative embodiment may feature integration with fishing regulation databases that provide real-time compliance monitoring and alerts. The system may automatically check current fishing regulations for specific locations and species, alerting users when they approach harvest limits or fishing restrictions. Regulation integration may include seasonal fishing restrictions, size limits, and bag limits that vary by location and species. The platform may provide automated warnings when users attempt to log catches that may exceed legal limits or occur during restricted seasons.

The platform may implement an alternative embodiment that supports custom data fields and user-defined event types beyond standard fishing activities. Users may configure personalized data collection templates that capture information specific to their fishing preferences or research interests. Custom event types may include equipment testing, bait effectiveness studies, or environmental condition experiments. The flexible data model may accommodate scientific research applications where users need to collect specialized data points not covered by standard fishing logbook formats.

An alternative implementation may provide integration with weather forecasting services that extend beyond current conditions to include predictive weather modeling for fishing trip planning. The system may access extended weather forecasts, marine weather bulletins, and specialized fishing weather services that provide detailed predictions about conditions affecting fish behavior. Weather integration may include barometric pressure trends, wind pattern forecasts, and precipitation predictions that influence fishing success rates. The platform may generate fishing trip recommendations based on favorable weather predictions and historical correlations between weather patterns and fishing success.

The interface also includes options for sharing the event log and photo on social media platforms such as Instagram, Facebook, Twitter, and Pinterest. This sharing functionality allows users to easily share their fishing experiences with friends and followers.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the methods disclosed herein.

### A. Generalized Method

Consistent with embodiments of the present disclosure, a method may be performed by at least one of the aforementioned modules. The method may be embodied as, for example, but not limited to, computer instructions, which, when executed, perform the method. The method may comprise the following stages:

Once a user has set up their account credentials and preferences, the user may begin operation of the platform via a mobile device. The platform may receive voice input from the user during a trip, such as a fishing trip. The voice input is processed using natural language processing (NLP) and/or natural language understanding (NLU) to identify trigger words signifying an event for inclusion in a logbook. Upon identifying these trigger words, the platform may take one or more specific actions. In particular, the platform may drop a pin on a map to mark an event location by retrieving at least geolocation data and a timestamp indicating the location and time of the event, respectively. The platform may collect data from one or more external DCDs connected thereto, adding additional environmental details related to the event. The platform may continue transcribing voice input from the user during the event. As one non-limiting example, in the case of a fishing event (e.g., the user catches a fish and uses the “fish on” keyword), the user may verbally indicate features of the fishing event, such as, species, size, fishing method, tackle used, etc. The platform may also collect various data from the internet related to the event. The method may also allow the user to tag one or more photos for inclusion in the logbook entry.

After the event has concluded (e.g., a certain period of time has elapsed, the user issues another trigger word concluding the event, a period of time elapses without voice input from the user, etc.), the data collected from the various data sources may be compiled into an electronic logbook entry. Moreover the platform may update summary statistics regarding the trip (e.g., a number of fish caught during the trip). The logbook entry may be added to an electronic logbook, which includes a timeline and summary statistics of the fishing event. The logbook may be stored in a cloud storage system for subsequent access and management.

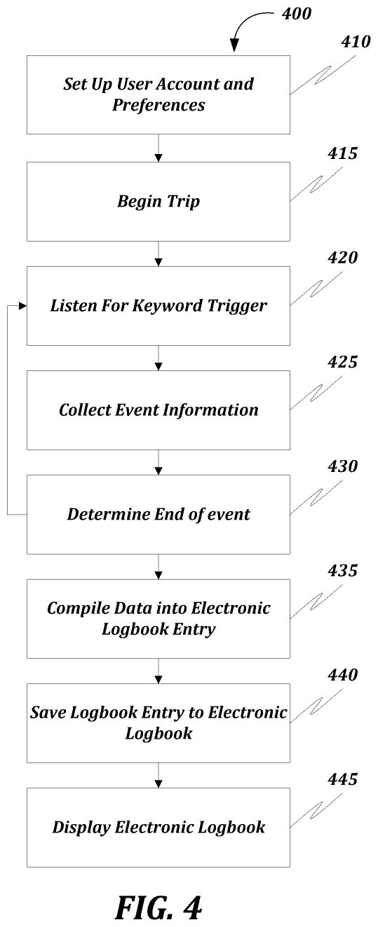

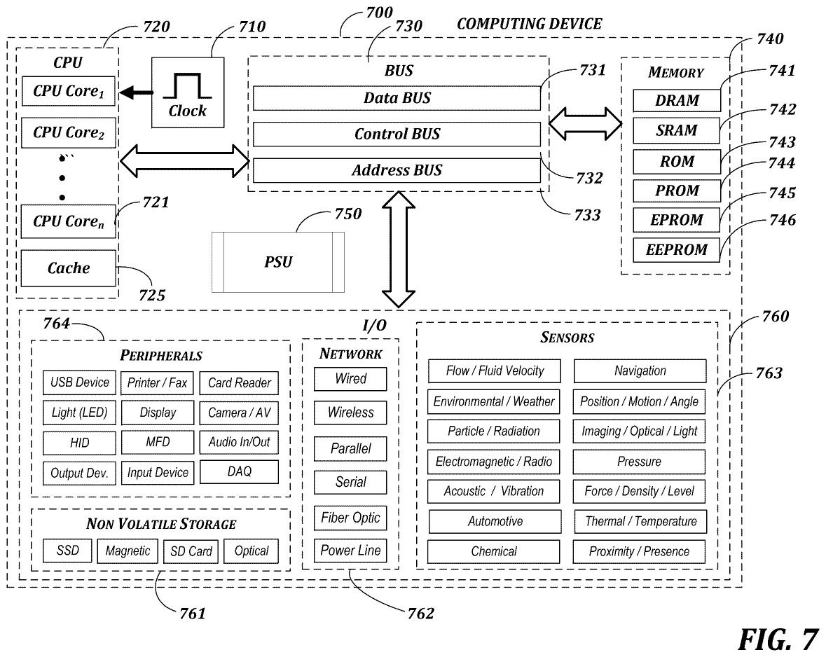

FIG. 4 is a flow chart setting forth the general stages involved in a method 400 consistent with an embodiment of the disclosure for providing the sport fishing data collection and logbook platform 100. Method 400 may be implemented using a computing device 700 or any other component associated with platform 100 as described in more detail below with respect to FIG. 7. For illustrative purposes alone, computing device 700 is described as one potential actor in the following stages.

Method 400 may begin at stage 410 where computing device 700 may create or modify a user account. For example, a user may establish or edit login credentials (e.g., username and password), set privacy controls (e.g., determining whether other users to view logbooks including associated location data, images, aggregated data without exact location information, and/or other privacy settings), set user preferences and demographic information (e.g., home location, preferred fishing styles, preferred tackle, favorite species of fish to catch, etc.). In some embodiments, the user may be prompted to indicate whether they are a private fisherman or a professional fishing guide.

In embodiments, user account information may be stored at a cloud-based storage system, allowing users to maintain and update accounts from various devices.

From stage 410, where computing device 700 establishes account information, method 400 may advance to stage 415 where a user may trigger the computing device 700 to begin a trip. In embodiments, the computing device may begin a trip responsive to a physical interaction with a mobile device associated with the platform. This may be the only physical interaction with a computing device required by the user.

After beginning a trip in stage 415, the method 400 may proceed to stage 420, where the computing device 700 may listen for a keyword to trigger an event. The computing device may use a microphone to receive input comprising an audio feed that captures user speech. The user speech may be provided to a natural language processing and/or natural language understanding process to compare the received user speech to one or more keywords that indicate the beginning of an event. As non-limiting examples, the keywords may include “fish on” or “take a note”.

In some embodiments, the platform may cause the device used to interface with the platform (e.g., a smartphone) to provide haptic and/or audio feedback in response to identification of a trigger keyword. This feedback may serve to notify the user that an event is being logged.

Once computing device 700 determines that the user has spoken a keyword to begin an event, in stage 420, method 400 may continue to stage 425 where computing device 700 may collect event information.

For example, the computing device may determine the geolocation of the device at the time the keyword is identified, and a timestamp associated with the keyword. Collecting event information may include transcribing user speech during the event. In some embodiments, the computing device may collect environmental information associated with the event. The environmental information may include (but need not be limited to) air temperature, water temperature, water depth, barometric pressure, wind speed, precipitation, moon phase, weather information, and/or any other information that may be relevant to the event.

Event information may be collected from one or more external data collection devices (DCDs) in operative communication with the platform. For example, DCDs may include thermometers, depth gauges, cameras, drones, or any other DCDs connected to the platform by the user. Additionally or alternatively, the computing device may receive event information from one or more information repositories accessible via the internet. Collecting the event information may include parsing the user speech transcription for data from a user. For example, in a fishing event, the user may specify a fish size (e.g., length and/or weight), a fish species, a tackle used to catch the fish, and/or any other information associated with the event. The event information may be collected during the event (e.g., in real-time or near real-time, or may be collected after the event based on the determined geolocation and timestamp data.

In some embodiments, collecting event information may include receiving one or more photographs and/or videos associated with the event. The one or more photographs may be received during the event, or may be received later and associated with the event by comparing metadata associated with the photo and/or video to the geolocation and/or timestamp data associated with the event.

At stage 430, the computing device 700 may determine an event end. For example, the event may be determined to end after a particular amount of time has elapsed since the beginning of the event, that a particular time threshold has elapsed without receiving any user speech, or that a user has provided a keyword indicating the end of an event (e.g., “fish landed”, “fish lost”, “fish harvested”, “fish released”).

Once the computing device 700 determines the end of the event in stage 430, the method 400 may proceed to stage 435, where the computing device 700 may create a logbook entry. Creating the logbook entry may include compiling the collected event information. In embodiments, the event information may be compiled in a structured data format to allow for uniform storage and display of events.

After creating the logbook event in stage 435, the method 400 may proceed to stage 440 where the computing device may store the logbook entry to an electronic logbook. For example, the logbook entry may be uploaded to a cloud storage device associated with the platform. The transmission of the logbook entry may be made using secure data transmission protocols to avoid compromising user data.

In some embodiments, the computing device may determine the end of a trip. For example, the trip may be determined to end after a certain time period elapses, after a certain amount of time passes without the addition of a new event, in response to a command received from the use (e.g., “end trip”), in response to a determination that the user has returned to a geolocation that substantially matches a geolocation associated with a beginning of the trip (e.g., a return to the start point), in response to a determination that the user is moving above a threshold speed (e.g., at automobile speeds). In embodiments, responsive to such a determination, the computing device may prompt the user to indicate whether the platform should pause or end recording, or continue.

In stage 445, the computing device may display the electronic logbook to the user. The user may be provided with a visual interface to access and interact with the electronic logbook and other collected data. Various display formats, including timelines, maps, and summary statistics, may be provided, allowing users to view their data in multiple contexts.

The display of the logbook may enable users to navigate through their fishing logbook, view detailed records of individual logged events, and analyze patterns and trends over time. The display may support interactive features, such as zooming in on specific map locations, filtering data based on criteria such as date, species, and/or fishing method, and accessing detailed information about each logged event. The display may allow a user to view photos and/or videos tagged to specific logged events, providing a comprehensive visual record of the fishing experiences. By offering a dynamic and interactive interface, the display enhances the overall user experience and facilitates efficient data management and analysis.

In some embodiments, the user may be able to add or edit details related to their trips. For example, the user may add reviews of travel accommodations (e.g., hotels, campgrounds, etc.). The user may also be able to move pins that have been placed during the trip. For example, if a user takes note of an eagle nest while in a stream, the pin may be positioned at the user location within the stream, while the eagle nest may be on the shore - the user may edit the pin location to more closely correspond to the location of the nest. The user may also add additional notes related to location (e.g., accessibility of provisions, locations of nearest stores relative to the fishing area, and/or the like. In some embodiments, the user may also review the trip as a whole (e.g., whether expectations for the trip were met, whether the user plans to revisit the location, etc.).

In some embodiments, the display may be formatted or presented differently for different screen sizes and/or resolutions.

### B. Specific Example Implementation

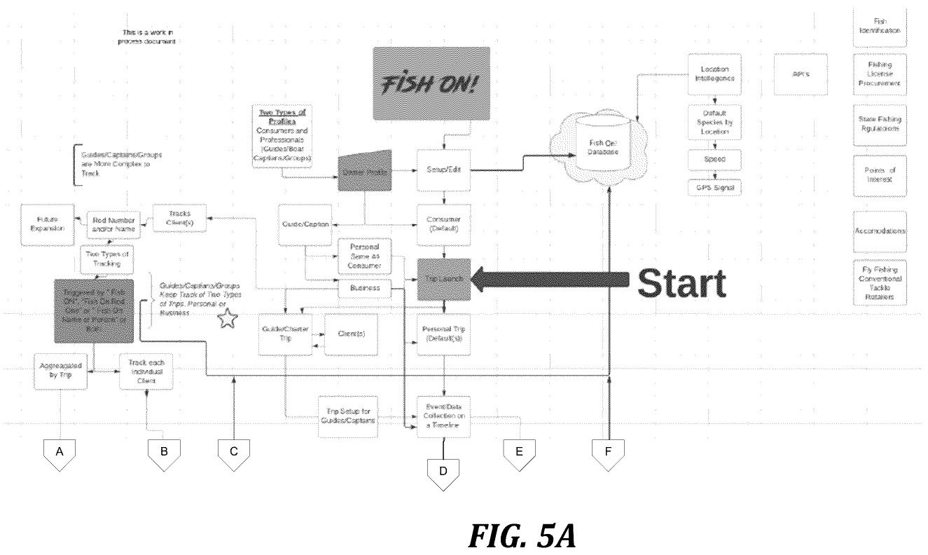

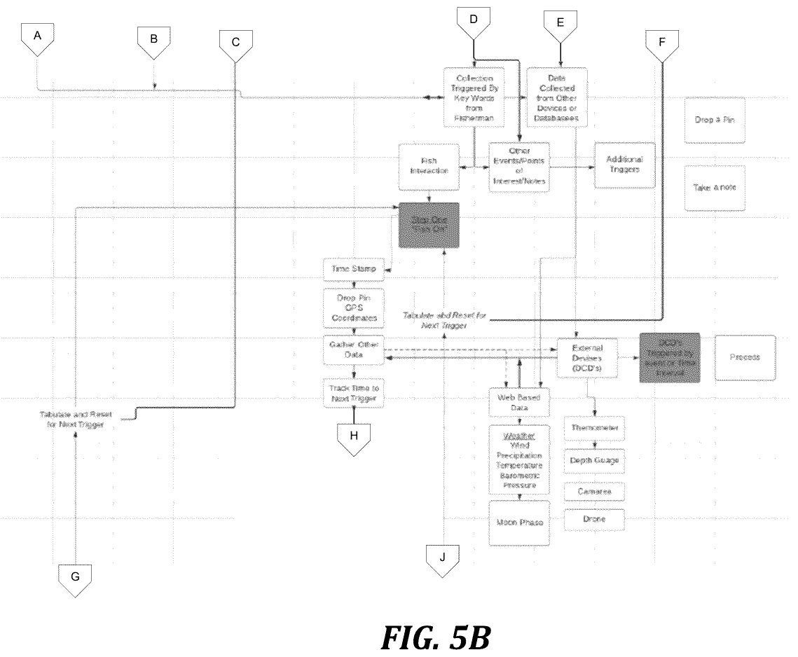

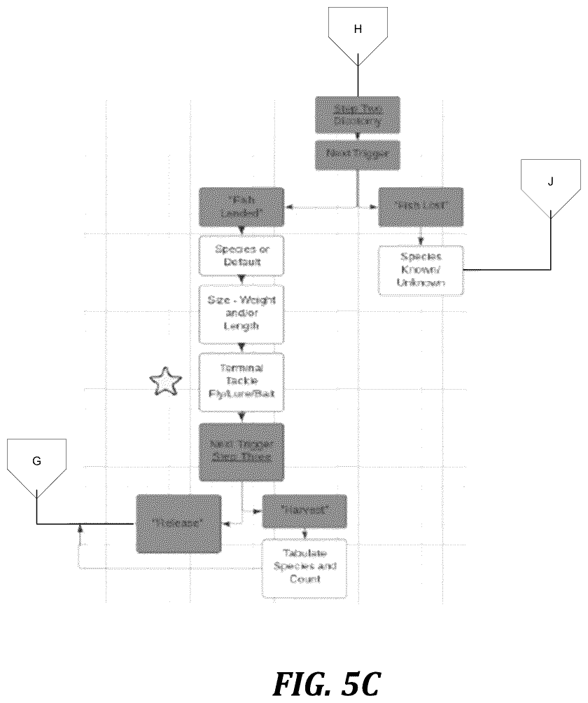

As shown in FIG. 5, a specific workflow may be used as a platform for sport fishing data collection and logbook creation. The workflow shows specific steps for account creation, event logging and data collection, and logbook storage. The workflow shows specific examples of trigger keywords used to move between stages of event logging. While the workflow shows very specific stages, those of skill in the art will recognize that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the method disclosed herein.

The workflow begins with the “Start” point, indicated by a large arrow pointing to the “Trip Launch” component. This component is central to initiating the data collection process for a fishing trip.

The workflow is divided into several sections, each representing different stages and functionalities of the platform. The “Setup/Edit” section allows users to configure their profiles and preferences. This section includes options for both “Owner Profile” and “Guide/Captain” profiles, catering to different types of users such as individual consumers and professional fishing guides or boat captains.

Once the “Trip Launch” is initiated, the workflow branches into two main paths: “Personal Trip (Default)” and “Business.” The “Personal Trip (Default)” path is designed for individual users, while the “Business” path is tailored for professional guides who need to track client fishing activities. The “Guide/Charter Trip” component under the “Business” path allows guides to set up trips for their clients, including the ability to track each individual client and aggregate data by trip.

The “Event/Data Collection on a Timeline” section is for logging fishing events. This section is triggered by words spoken by the fisherman, such as “Fish On!” which initiates the data collection process. The workflow includes components for “Fish Interaction,” “Other Events/Points of Interest/Notes,” and “Additional Triggers” like “Drop a Pin” and “Take a Note.”

The “Fish Interaction” component is further detailed into steps. “Step One ‘Fish On!’” involves dropping a pin with GPS coordinates, timestamping the event, and gathering other relevant data. The workflow then tracks the time to the next trigger, leading to “Step Two Dichotomy,” which differentiates between “Fish Landed” and “Fish Lost” events. For “Fish Landed,” additional data such as species, size, weight, length, and terminal tackle used are logged. The workflow then proceeds to “Step Three,” where the fish is either “Released” or “Harvested,” and the species and count are tabulated.

The workflow also integrates data from external devices (DCDs) such as thermometers, depth gauges, cameras, and drones. These devices can be triggered by events or time intervals to provide additional data points. The “Web Based Data” component retrieves environmental data such as weather, wind, precipitation, temperature, barometric pressure, and moon phase, further enriching the dataset.

The “Fish On!” database stores all collected data, which can be accessed and managed through the platform. The workflow ensures that data is compiled into an electronic logbook, providing a comprehensive and detailed record of each fishing trip. The platform supports both individual and professional users, offering features to track personal and client fishing activities while ensuring data privacy and security.

### C. Collecting and Logging Sport Fishing Data

Consistent with embodiments of the present disclosure, a computer implemented method for collecting and logging sport fishing data may be performed by at least one of the aforementioned modules. The method may be embodied as, for example, but not limited to, computer instructions, which, when executed, perform the method.

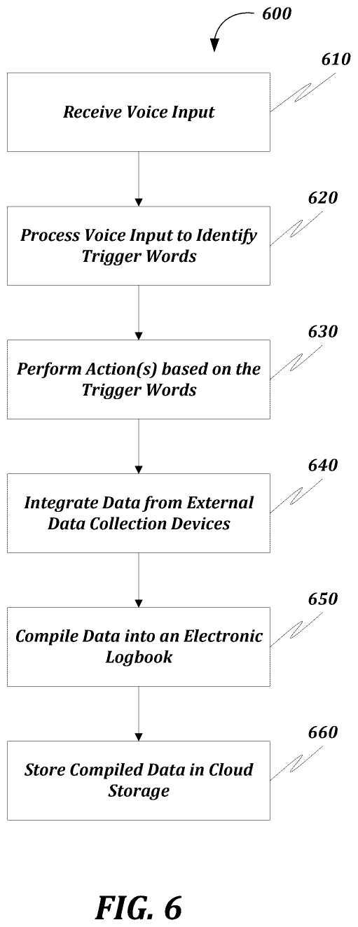

FIG. 6 illustrates a method 600 for collecting and logging sport fishing data through a voice-activated system that provides hands-free data collection during fishing activities. The method 600 may be implemented using computing device 700 or any other component associated with platform 100. The method 600 demonstrates the sequential processing stages that enable comprehensive fishing data collection and logging without manual intervention during active fishing moments.

Method 600 may begin at stage 610 where computing device 700 may receive voice input from a user during a fishing event. The voice input reception may occur through microphone systems integrated into mobile devices or external audio capture devices connected to the platform. The voice input may include natural speech patterns containing fishing-related terminology and trigger words that indicate specific fishing events or activities. The system may continuously monitor ambient audio to capture voice input without requiring manual activation by the user during fishing activities.

The voice input reception stage may employ noise filtering algorithms to distinguish between relevant speech and environmental background sounds common in outdoor fishing environments. As non-limiting examples, wind noise, water sounds, and other ambient audio may be filtered to improve the accuracy of voice recognition processing. The system may adjust sensitivity levels based on environmental conditions to maintain consistent voice input capture across different fishing scenarios.

Voice input may be captured in real-time during active fishing events to ensure immediate processing and response to user commands. The system may buffer audio input to account for variations in speech patterns and timing while maintaining responsiveness to trigger words. Multiple microphone configurations may be supported to accommodate different device orientations and user positions during fishing activities.

From stage 610, method 600 may advance to stage 620 where computing device 700 may process the voice input using natural language processing and natural language understanding algorithms to identify trigger words. The natural language processing may analyze speech patterns to extract meaningful phrases and commands from continuous audio streams. Trigger word identification may involve pattern matching algorithms that recognize predefined and/or fishing-related terminology such as “fish on,” “take a note,” “fish landed,” or “fish lost.”

The natural language processing stage may employ machine learning models trained on fishing-specific vocabulary and speech patterns to improve recognition accuracy. Regional dialects and variations in fishing terminology may be accommodated through adaptive learning algorithms that adjust to individual user speech characteristics. The system may maintain context awareness to distinguish between casual conversation and intentional commands directed at the data collection system.

Real-time processing may occur locally on the mobile device to minimize latency between voice input and system response, and/or to allow for processing in remote areas where connectivity is not present. Edge computing capabilities may enable immediate trigger word recognition without requiring cloud-based processing for basic command identification. Advanced natural language understanding may extract additional context and details from user speech beyond basic trigger word recognition.

Method 600 may continue to stage 630 where computing device 700 may perform actions based on the identified trigger words. The actions performed may vary depending on the specific trigger words detected and may include multiple simultaneous operations. Location marking may occur through GPS coordinate capture and map pin placement to record the precise geographic position of fishing events. Timestamp recording may document the exact time of each triggered event for chronological organization of fishing activities.

Data retrieval operations may be initiated automatically upon trigger word detection to gather relevant environmental and contextual information. Internet-based data services may be queried to obtain weather conditions, barometric pressure readings, moon phase information, and other environmental factors that may influence fishing success. The system may correlate trigger word detection with ongoing data collection processes to ensure comprehensive event documentation.

User feedback may be provided through haptic vibration or audio confirmation to indicate successful trigger word recognition and action initiation. Visual indicators on mobile device displays may show active data collection status and confirm that fishing events are being properly logged. The system may continue monitoring for additional trigger words while processing current events to capture sequential fishing activities.

From stage 630, method 600 may proceed to stage 640 where computing device 700 may integrate data from external data collection devices to enhance the collected dataset. External device communication may occur through wireless protocols such as Bluetooth, WiFi, or other supported communication methods. Water temperature sensors, depth gauges, weather monitoring equipment, and other specialized fishing devices may contribute additional environmental parameters to each logged event.

Device integration may involve automatic discovery and connection to compatible external sensors within communication range. Data synchronization may ensure that external device readings are properly associated with specific fishing events based on timestamp correlation. The system may support multiple simultaneous connections to different types of external devices to create comprehensive environmental profiles for each fishing location.

External device data may be validated and processed to ensure accuracy and consistency with other collected information. Sensor calibration data may be applied to raw measurements to provide accurate environmental readings. The system may maintain device status monitoring to detect connection issues or sensor malfunctions that might affect data quality.

Method 600 may advance to stage 650 where computing device 700 may compile the collected data into an electronic logbook entry. Data compilation may involve organizing information from multiple sources into structured logbook formats suitable for storage and display. GPS coordinates, timestamps, environmental data, user speech transcripts, and external sensor readings may be combined into cohesive event records.

Statistical calculations may be performed during compilation to generate summary information such as catch rates, trip duration, and species distribution. The system may apply data validation algorithms to identify and correct inconsistencies or missing information in compiled records. Default values may be inserted for incomplete data fields based on user preferences, location characteristics, or historical patterns.

Photo and video integration may occur during compilation to associate visual media with specific fishing events based on metadata correlation. The system may analyze timestamp and location information from captured media to automatically tag images and videos to corresponding logbook entries. Multiple data formats may be supported to accommodate different types of information and ensure compatibility with various display and analysis tools.

Method 600 may conclude at stage 660 where computing device 700 may store the compiled data in cloud storage systems for subsequent access and management. Cloud storage operations may involve secure data transmission using encryption protocols to protect sensitive information during upload processes. Data synchronization may ensure that logbook entries are consistently available across multiple user devices and platforms.

Storage organization may structure data in searchable formats that enable efficient retrieval and analysis of fishing records over time. Backup and redundancy systems may protect against data loss while maintaining accessibility for authorized users. Privacy controls may be applied during storage to manage the visibility of location-specific information and other sensitive data.

The cloud storage system may support data export capabilities that allow users to extract their fishing records in various formats for external analysis or sharing. Integration with third-party applications and services may be facilitated through standardized data interfaces and API access. The system may maintain version control and audit trails to track changes and updates to stored fishing data over time.

### IV. Computer Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 700. The computing device 700 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;
Platform 100 may be hosted on a centralized server or a cloud computing service. Although method 400 has been described to be performed by a computing device 700, it should be understood that, in some embodiments, different operations may be performed by a plurality of the computing devices 700 in operative communication on at least one network.

Embodiments of the present disclosure may comprise a system having a central processing unit (CPU) 720, a bus 730, a memory unit 740, a power supply unit (PSU) 750, and one or more Input/Output (I/O) units. The CPU 720 coupled to the memory unit 740 and the plurality of I/O units 760 via the bus 730, all of which are powered by the PSU 750. It should be understood that, in some embodiments, each disclosed unit may actually be a plurality of such units for redundancy, high availability, and/or performance purposes. The combination of the presently disclosed units is configured to perform the stages of any method disclosed herein.

FIG. 7 is a block diagram of a system including computing device 700. Consistent with an embodiment of the disclosure, the aforementioned CPU 720, the bus 730, the memory unit 740, a PSU 750, and the plurality of I/O units 760 may be implemented in a computing device, such as computing device 700 of FIG. 7. Any suitable combination of hardware, software, or firmware may be used to implement the aforementioned units. For example, the CPU 720, the bus 730, and the memory unit 740 may be implemented with computing device 700 or any of other computing devices 700, in combination with computing device 700. The system shown in FIG. 7 is intended only to serve as an example; other systems, devices, and/or components may comprise the aforementioned CPU 720, the bus 730, and the memory unit 740, consistent with embodiments of the disclosure.

At least one computing device 700 may be embodied as any of the computing elements illustrated in all of the attached figures. A computing device 700 does not need to be electronic, nor even have a CPU 720, nor bus 730, nor memory unit 740. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In some configurations, the computing device 700 may include at least one clock module 710, at least one CPU 720, at least one bus 730, and at least one memory unit 740, at least one PSU 750, and at least one I/O 760 module, wherein I/O module may be comprised of, but not limited to a non-volatile storage sub-module 761, a communication sub-module 762, a sensors sub-module 763, and a peripherals sub-module 764.

In a system consistent with an embodiment of the disclosure, the computing device 700 may include the clock module 710, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 720, the central component of modern computers, which relies on a clock signal. The clock 710 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 700 may use a “clock multiplier” which multiplies a lower frequency external clock to the appropriate clock rate of the CPU 720. This allows the CPU 720 to operate at a much higher frequency than the rest of the computing device 700, which affords performance gains in situations where the CPU 720 does not need to wait on an external factor (like memory 740 or input/output 760). Some embodiments of the clock 710 may include dynamic frequency change, where, the time between clock edges can vary widely from one edge to the next and back again.

In a system consistent with an embodiment of the disclosure, the computing device 700 may include the CPU 720 comprising at least one CPU Core 721. In other embodiments, the CPU 720 may include a plurality of identical CPU cores 721, such as, but not limited to, homogeneous multi-core systems. It is also possible for the plurality of CPU cores 721 to comprise different CPU cores 721, such as, but not limited to, heterogeneous multi-core systems, big. LITTLE systems and some AMD accelerated processing units (APU). The CPU 720 reads and executes program instructions which may be used across many application domains, for example, but not limited to, general purpose computing, embedded computing, network computing, digital signal processing (DSP), and graphics processing (GPU). The CPU 720 may run multiple instructions on separate CPU cores 721 simultaneously. The CPU 720 may be integrated into at least one of a single integrated circuit die, and multiple dies in a single chip package. The single integrated circuit die and/or the multiple dies in a single chip package may contain a plurality of other elements of the computing device 700, for example, but not limited to, the clock 710, the bus 730, the memory 740, and I/O 760.

The CPU 720 may contain cache 722 such as but not limited to a level 1 cache, a level 2 cache, a level 3 cache, or combinations thereof. The cache 722 may or may not be shared amongst a plurality of CPU cores 721. The cache 722 sharing may comprise at least one of message passing and inter-core communication methods used for the at least one CPU Core 721 to communicate with the cache 722. The inter-core communication methods may comprise, but not be limited to, bus, ring, two-dimensional mesh, and crossbar. The aforementioned CPU 720 may employ symmetric multiprocessing (SMP) design.

The one or more CPU cores 721 may comprise soft microprocessor cores on a single field programmable gate array (FPGA), such as semiconductor intellectual property cores (IP Core). The architectures of the one or more CPU cores 721 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the computing device 700, and/or the plurality of computing devices 700. The aforementioned communication system will be known to a person having ordinary skill in the art as a bus 730. The bus 730 may embody internal and/or external hardware and software components, for example, but not limited to a wire, an optical fiber, various communication protocols, and/or any physical arrangement that provides the same logical function as a parallel electrical bus. The bus 730 may comprise at least one of a parallel bus, wherein the parallel bus carries data words in parallel on multiple wires; and a serial bus, wherein the serial bus carries data in bit-wise serial form. The bus 730 may embody a plurality of topologies, for example, but not limited to, a multidrop/electrical parallel topology, a daisy chain topology, and connected by switched hubs, such as a USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface / Firewire, Thunderbolt, and eXtensible Host Controller Interface (xHCI).

Consistent with the embodiments of the present disclosure, the aforementioned computing device 700 may employ hardware integrated circuits that store information for immediate use in the computing device 700, known to persons having ordinary skill in the art as primary storage or memory 740. The memory 740 operates at high speed, distinguishing it from the non-volatile storage sub-module 761, which may be referred to as secondary or tertiary storage, which provides relatively slower-access to information but offers higher storage capacity. The data contained in memory 740, may be transferred to secondary storage via techniques such as, but not limited to, virtual memory and swap. The memory 740 may be associated with addressable semiconductor memory, such as integrated circuits consisting of silicon-based transistors, that may be used as primary storage or for other purposes in the computing device 700. The memory 740 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 741, Static Random-Access Memory (SRAM) 742, CPU Cache memory 725, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 743, Programmable ROM (PROM) 744, Erasable PROM (EPROM) 745, Electrically Erasable PROM (EEPROM) 746 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 700 may employ a communication system between an information processing system, such as the computing device 700, and the outside world, for example, but not limited to, human, environment, and another computing device 700. The aforementioned communication system may be known to a person having ordinary skill in the art as an Input/Output (I/O) module 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces with a plurality of hardware, such as, but not limited to, non-volatile storage 761, communication devices 762, sensors 763, and peripherals 764. The plurality of hardware is used by at least one of, but not limited to, humans, the environment, and another computing device 700 to communicate with the present computing device 700. The I/O module 760 may comprise a plurality of forms, for example, but not limited to channel I/O, port mapped I/O, asynchronous I/O, and Direct Memory Access (DMA).

Consistent with the embodiments of the present disclosure, the aforementioned computing device 700 may employ a non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 740. The non-volatile storage sub-module 761 may not lose data when power is removed and may be orders of magnitude less costly than storage used in memory 740. Further, the non-volatile storage sub-module 761 may have a slower speed and higher latency than in other areas of the computing device 700. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
   Deoxyribonucleic Acid (dna) Digital Data Storage

Consistent with the embodiments of the present disclosure, the computing device 700 may employ a communication sub-module 762 as a subset of the I/O module 760, which may be referred to by a person having ordinary skill in the art as at least one of, but not limited to, a computer network, a data network, and a network. The network may allow computing devices 700 to exchange data using connections, which may also be known to a person having ordinary skill in the art as data links, which may include data links between network nodes. The nodes may comprise networked computer devices 700 that may be configured to originate, route, and/or terminate data. The nodes may be identified by network addresses and may include a plurality of hosts consistent with the embodiments of a computing device 700. Examples of computing devices that may include a communication sub-module 762 include, but are not limited to, personal computers, phones, servers, drones, and networking devices such as, but not limited to, hubs, switches, routers, modems, and firewalls.

Two nodes can be considered networked together when one computing device 700 can exchange information with the other computing device 700, regardless of any direct connection between the two computing devices 700. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4[IPv4 ], and Internet Protocol version 6[IPv6 ]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 762 may comprise a plurality of size, topology, traffic control mechanisms and organizational intent policies. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).

### Power Line Communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 700 may employ a sensors sub-module 763 as a subset of the I/O 760. The sensors sub-module 763 comprises at least one of the device, module, or subsystem whose purpose is to detect events or changes in its environment and send the information to the computing device 700. Sensors may be sensitive to the property they are configured to measure, may not be sensitive to any property not measured but be encountered in its application, and may not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte- insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/il level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, Weather, Moisture, and Humidity Sensors, Such As, but Not Limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ a peripherals sub-module 764 as a subset of the I/O 760. The peripheral sub-module 764 comprises ancillary devices uses to put information into and get information out of the computing device 700. There are 3 categories of devices comprising the peripheral sub-module 764, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 700. Output devices convert electronically generated information into a form that can be presented to humans. Input/output devices perform both input and output functions. It should be understood by a person having ordinary skill in the art that the ensuing are non-limiting embodiments of the aforementioned peripheral sub-module 764:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 700. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 700 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 762), data storage devices (non-volatile storage 761), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A computer-implemented method for collecting and logging sport fishing data, comprising:
receiving, by a mobile device, voice input from a user during a fishing event;
processing, by the mobile device, the voice input using natural language processing (NLP) and natural language understanding (NLU) to identify key trigger words;
performing, by the mobile device, actions based on the identified key trigger words, wherein the actions comprise:
dropping pins on a map to mark locations,
retrieving data from the internet related to the fishing event, or
logging data points comprising one or more of: GPS coordinates, species, size, fishing method, tackle used, weather conditions, water conditions, and timestamps;
integrating, by the mobile device, data from external data collection devices (DCDs) via wireless communication to enhance the data set;
compiling, by the mobile device, the logged data into an electronic logbook, wherein the logbook comprises a timeline and summary statistics of the fishing event; and
storing, by a cloud storage system, the compiled data for subsequent access and management.

2. The method of claim 1, wherein the key trigger words comprise phrases selected from the group consisting of “fish on,” “take a note,” “fish landed,” and “fish lost.”

3. The method of claim 1, further comprising notifying the user of detected events through one or more of haptic feedback or audio alerts.

4. The method of claim 1, wherein the data retrieved from the internet comprises environmental data selected from the group consisting of real-time weather conditions, moon phase, and barometric pressure.

5. The method of claim 1, further comprising filtering the voice input to remove background noise and improve accuracy of the natural language processing.

6. The method of claim 1, wherein the external DCDs comprise devices selected from the group consisting of stream thermometers, water depth gauges, and weather sensors.

7. The method of claim 1, further comprising allowing the user to edit the compiled data in the electronic logbook through a web interface.

8. The method of claim 7, wherein the electronic logbook comprises a photo gallery of images tagged to specific fishing events.

9. A system for collecting and logging sport fishing data, comprising:
a mobile device comprising a processor, memory, microphone, GPS module, and wireless communication interface;
a voice interaction module configured to receive voice input from a user during a fishing event;
a natural language processing module configured to process the voice input to identify key trigger words;
an event logging module configured to perform actions based on the identified key trigger words, wherein the actions comprise dropping pins on a map, retrieving environmental data, and logging data points comprising GPS coordinates, species information, and timestamps;
an integration module configured to receive data from external data collection devices via the wireless communication interface;
a data compilation module configured to compile the logged data into an electronic logbook comprising a timeline and summary statistics;
a cloud storage system configured to store the compiled data; and
a display module configured to present the electronic logbook to the user.

10. The system of claim 9, wherein the mobile device further comprises sensors selected from the group consisting of accelerometer, gyroscope, barometric pressure sensor, and temperature sensor.

11. The system of claim 9, wherein the external data collection devices comprise wireless sensors configured to measure environmental parameters selected from the group consisting of water temperature, water depth, and atmospheric pressure.

12. The system of claim 9, further comprising a web interface module configured to provide remote access to the electronic logbook through a browser-based application.

13. The system of claim 9, wherein the voice interaction module comprises noise filtering functionality configured to improve accuracy of voice recognition in outdoor environments.

14. The system of claim 9, wherein the data compilation module comprises statistical analysis functionality configured to generate hourly catch rates and species distribution summaries.

15. A computer-readable storage medium storing instructions that, when executed by a processor of a mobile device, cause the mobile device to perform operations comprising:
receiving voice input from a user during a fishing event;
processing the voice input using natural language processing (NLP) and natural language understanding (NLU) to identify key trigger words;
performing actions based on the identified key trigger words, wherein the actions comprise:
dropping pins on a map to mark locations;
retrieving environmental data from internet sources;
logging data points comprising GPS coordinates, species, size, fishing method, tackle used, weather conditions, water conditions, and timestamps;
integrating data from external data collection devices (DCDs) via wireless communication to enhance the data set;
compiling the logged data into an electronic logbook comprising a timeline and summary statistics of the fishing event;
storing the compiled data in a cloud storage system for subsequent access and management;
allowing the user to set up profiles and preferences; and
providing options for professional guides to track personal versus client fishing activities.

16. The computer-readable storage medium of claim 15, wherein the key trigger words comprise phrases selected from the group consisting of “fish on,” “take a note,” “fish landed,” and “fish lost.”

17. The computer-readable storage medium of claim 15, wherein the operations further comprise providing haptic feedback to the user upon detection of the key trigger words.

18. The computer-readable storage medium of claim 15, wherein the environmental data comprises real-time weather conditions, moon phase, and barometric pressure retrieved from internet-based data sources.

19. The computer-readable storage medium of claim 15, wherein the operations further comprise filtering the voice input to remove background noise and improve accuracy of the natural language processing.

20. The computer-readable storage medium of claim 15, wherein the electronic logbook comprises a photo gallery of images tagged to specific fishing events based on time proximity and location data.
